(19) United States
(12) Patent Application Publication
(10) Pub. No.: US 2026/0093391 A1
(43) Pub. Date: Apr. 2, 2026

(54) SYSTEMS AND METHODS FOR SCROLLING CONTENT

(71) Applicant: Apple Inc., Cupertino, CA (US)

(72) Inventor: Gregory LUTTER, Boulder Creek, CA (US)

(21) Appl. No.: 19/319,464

(22) Filed: Sep. 4, 2025

Related U.S. Application Data
(60) Provisional application No. 63/700,597, filed on Sep. 27, 2024.

(51) Int. Cl. G06F 3/0485; G06F 3/01; G06F 3/0487

(52) U.S. Cl. CPC G06F 3/0485; G06F 3/012; G06F 3/017; G06F 3/0487

(57) ABSTRACT

An electronic device may display a user interface that includes content that is vertically scrollable in the user interface. The electronic device may vertically scroll the content in the user interface in accordance with yaw movement of a head of a user of the electronic device. An electronic device may display a user interface of an application. The electronic device may display a plurality of user interface elements in response to detecting a first input corresponding to a request to display the plurality of user interface elements, where the first input includes a first head rotation of a head of a user of the electronic device about a first axis associated with the head of the user. The plurality of user interface elements may be scrollable in response to a second head rotation of a second input that is different from the first input.

### CROSS REFERENCE TO RELATED APPLICATIONS

This application claims the benefit of U.S. Provisional Application No. 63/700,597, filed Sep. 27, 2024, the entire disclosure of which is herein incorporated by reference for all purposes.

### FIELD OF THE DISCLOSURE

This relates generally to systems and methods for scrolling computer-generated content.

### BACKGROUND OF THE DISCLOSURE

Some computer graphical environments provide two-dimensional and/or three-dimensional environments where at least some objects displayed for a user's viewing are virtual and generated by a computer. For example, a plurality of content items is often presented in computer graphical environments as a scrollable list.

### SUMMARY OF THE DISCLOSURE

An electronic device may display a user interface that includes content that is vertically scrollable in the user interface. While displaying the user interface including the content, the electronic device may detect a first input that corresponds to a request to scroll the content, where the first input includes a yaw movement of a head of a user of the electronic device. In response to detecting the yaw movement of the head of the user of the electronic device, the electronic device may vertically scroll the content in the user interface in accordance with the yaw movement of the head of the user.

An electronic device may display a user interface of an application. While displaying the user interface of the application, the electronic device may detect a first input corresponding to a request to display a plurality of user interface elements, where the first input includes a first head rotation of a head of a user of the electronic device about a first axis associated with the head. In response to detecting the first head rotation of the head of the user of the electronic device about the first axis, the electronic device may display the plurality of user interface elements. The plurality of user interface elements may be scrollable in response to a second head rotation of a second input that is different from the first input.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIGS. 2A-2B illustrate block diagrams of example architectures for electronic devices according to some examples of the disclosure.

FIGS. 3A-3K generally illustrate an electronic device vertically scrolling content in a user interface in response to detecting yaw movement of a head of a user of the electronic device according to some examples of the disclosure.

FIG. 3L generally illustrates a method for vertically scrolling content in a user interface in response to detecting yaw movement of a head of a user of the electronic device according to some examples of the disclosure.

FIGS. 4A-4T generally illustrate an electronic device detecting and responding to inputs that correspond to requests to display one or more user interface elements, where the inputs include head rotations of a user of the electronic device according to some examples of the disclosure.

FIG. 4U generally illustrates a method for displaying a plurality of user interface elements in response to detecting a head rotation of a user of an electronic device according to some examples of the disclosure.

FIGS. 5A-5F generally illustrate examples of an electronic device displaying different amounts of a user interface in accordance with different amounts of head rotations of a user of the electronic device according to some examples of the disclosure.

### DETAILED DESCRIPTION

An electronic device may display (e.g., in a two-dimensional environment or three-dimensional environment) a user interface that includes content that is vertically scrollable in the user interface. While displaying the user interface including the content, the electronic device may detect a first input that corresponds to a request to scroll the content, where the first input includes a yaw movement of a head of a user of the electronic device. In response to detecting the yaw movement of the head of the user of the electronic device, the electronic device may vertically scroll the content in the user interface in accordance with the yaw movement of the head of the user.

An electronic device may display (e.g., in a two-dimensional environment or three-dimensional environment) a user interface of an application. While displaying the user interface of the application, the electronic device may detect a first input corresponding to a request to display a plurality of user interface elements, where the first input includes a first head rotation of a head of a user of the electronic device about a first axis associated with the head. In response to detecting the first head rotation of the head of the user of the electronic device about the first axis, the electronic device may display the plurality of user interface elements. The plurality of user interface elements may be scrollable in response to a second head rotation of a second input that is different from the first input.

Note that, in some examples, detecting head movement of the user of the electronic device includes detecting movement of the electronic device that corresponds to movement of a head of a user of the electronic device. For example, detecting an upward pitch movement of the head of the user of the electronic device may include detecting a rotation of the electronic device that corresponds to an upward pitch movement of the head of the user of the electronic device.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a body-locked orientation, a head-locked orientation, a world-locked orientation, or a tilt-locked orientation, as described below.

As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as the viewpoint of the user changes). For example, when the object (e.g., virtual content) is head-locked, and in accordance with detection of head movement, electronic device 101 optionally displays the object moving within a three-dimensional environment in accordance with the user's head movement, optionally in order to maintain (e.g., lock) a position of object on display 120 and a distance of the object relative to the head of the user. As another example, when head-locked, the object is locked to (e.g., displayed via) a first set of pixels (e.g., a predefined number or area of pixels) on display 120 without being locked to (e.g., displayed via) a second set of pixels, such that the object is maintained on display 120 via the first set of pixels even when the user's moves the user's head. As another example, when head-locked, movement of display 120 optionally results in movement of the object relative to a physical environment of electronic device 101. In some examples, when an object is head-locked, the behavior of the object is head-locked with elasticity, such as described below.

For example, when the object is head-locked with elasticity, electronic device 101 optionally causes the object to visually behave as head-locked content in accordance with an elasticity model. In some examples, the elasticity model implements physics to the user's interaction in the virtual environment so that the interaction is governed by the law of physics, such by laws relating to springs. For example, the head position and/or head orientation of the user optionally corresponds to a location of a first end of a spring (e.g., simulating a first end of the spring being attached to an object) and the object optionally corresponds to a mass attached to a second end of the spring, different from (e.g., opposite) the first end of the spring. While the head position and/or orientation is a first head position and/or first orientation that corresponds to a first location of the first end of the spring and the object corresponds to the mass attached to the second end of the spring, the electronic device 101 optionally detects head movement (e.g., head rotation) from the first head position and/or first head orientation to a second head position and/or second head orientation. In response to the detection of the head rotation, the electronic device 101 optionally models deformity of the spring (e.g., in accordance with the amount of head rotation and/or speed of head rotation), and moves the object in accordance with release of the energy that is due to the spring's movement toward an equilibrium position (e.g., a stable equilibrium position) relative to the second head position and/or second head orientation. The speed at which the object follows the head rotation is optionally a function of the distance between the location of the object when the electronic device detects the head rotation and the location of the object that would correspond to a relaxed position of the spring (e.g., an equilibrium position), which would optionally be a location, that, relative to the user's new viewpoint resulting from the head rotation, is the same as the location of the object relative to the user's viewpoint before the head rotation is detected. In some examples, as the object moves towards to the relaxed position in response to the head rotation, the speed of the first virtual content decreases. In some examples, the head of the user is rotated a first amount within a first amount of time, and the movement of the object to its new location relative to the new viewpoint of the user is performed within a second amount of time that is greater than the first amount of time. As such, when the object is head-locked with elasticity, in accordance with detection of head movement, electronic device 101 may display the object moving within a three-dimensional environment in accordance with the user's head movement and in accordance with an elasticity model mimicking a lazy follow movement behavior. Head-locked with elasticity may be useful for smoothing out the movement of the object in the three-dimensional environment when the user moves (e.g., rotates the user's head).

As used herein, an object that is displayed in a world-locked orientation in a three-dimensional environment does not have a distance or orientation offset (e.g., a fixed distance or orientation offset) relative to the user.

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction, rotation about a pitch axis), the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise rotation about a roll axis), the tilt-locked object is not repositioned (e.g., reoriented) within the three-dimensional environment.

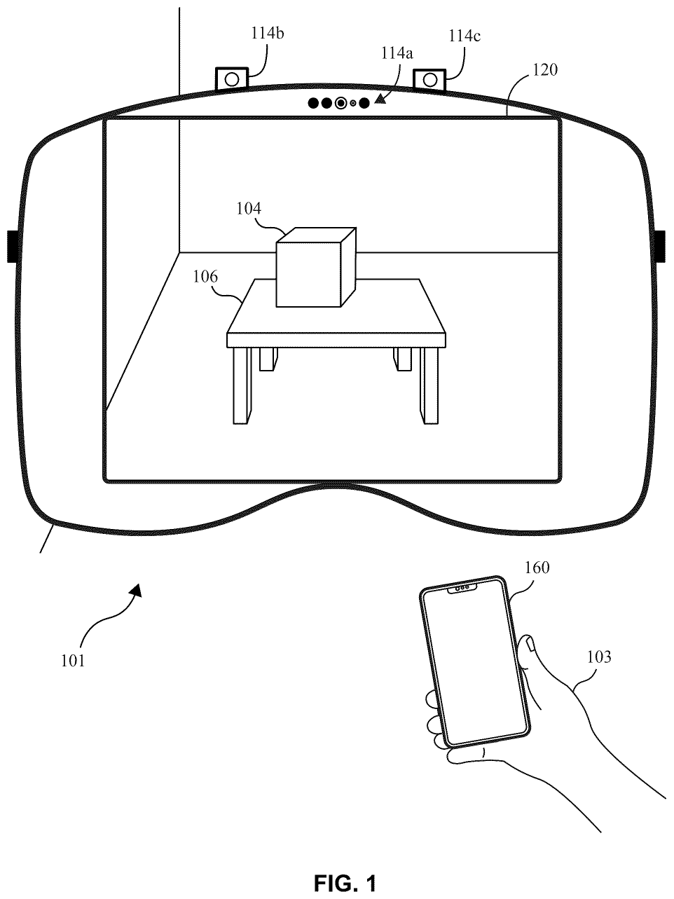

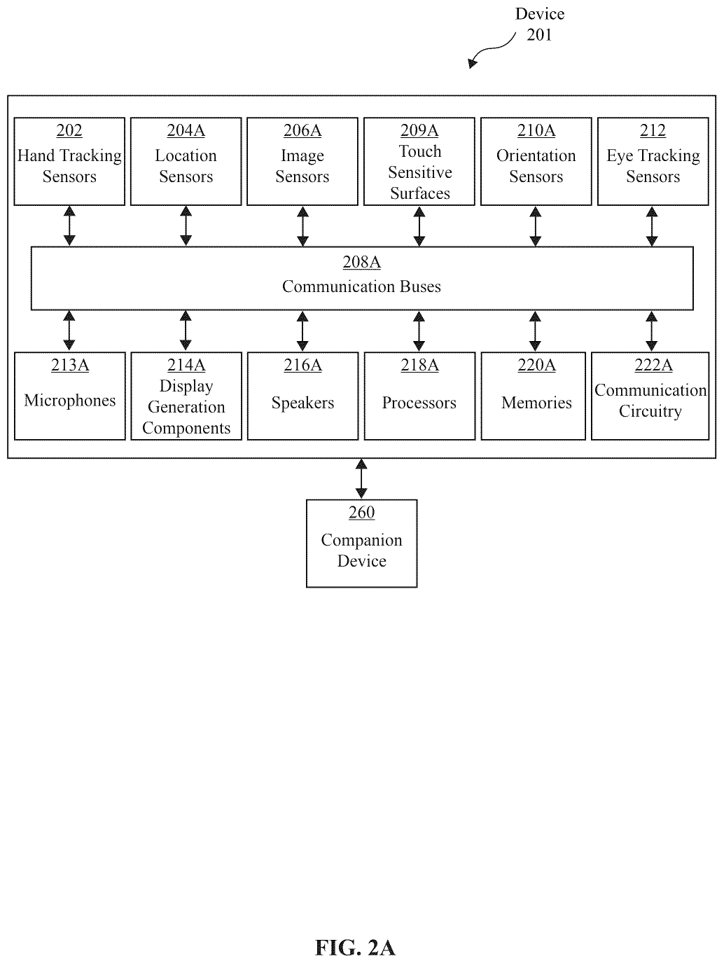

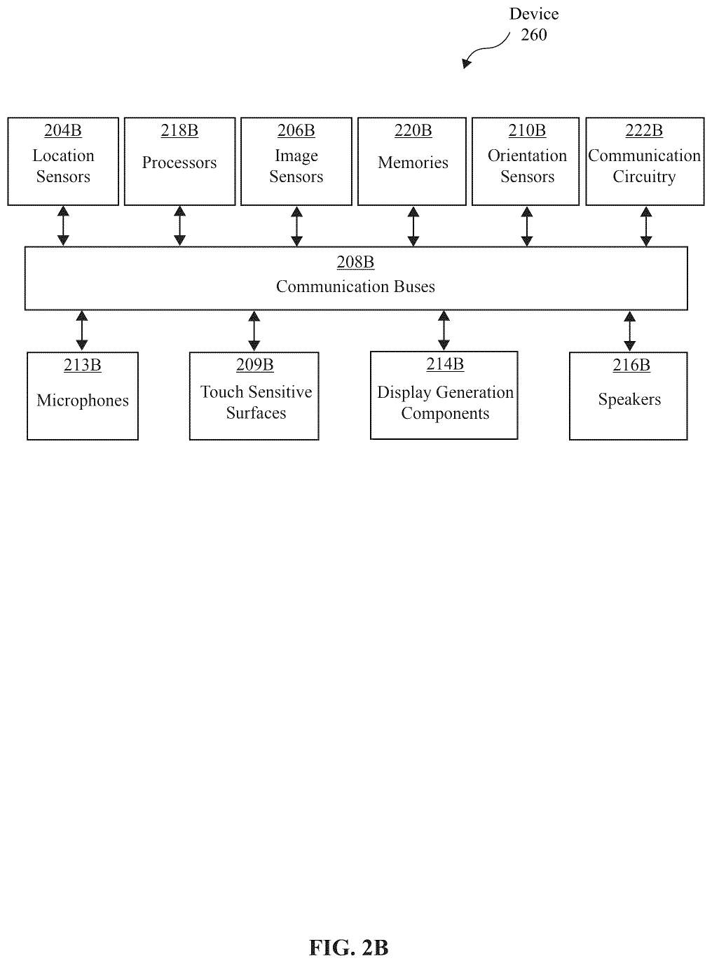

FIG. 1 illustrates an electronic device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specfies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now generally directed towards examples of an electronic device vertically scrolling content in a user interface in response to detecting yaw movements of a head of a user of the electronic device according to some examples of the disclosure.

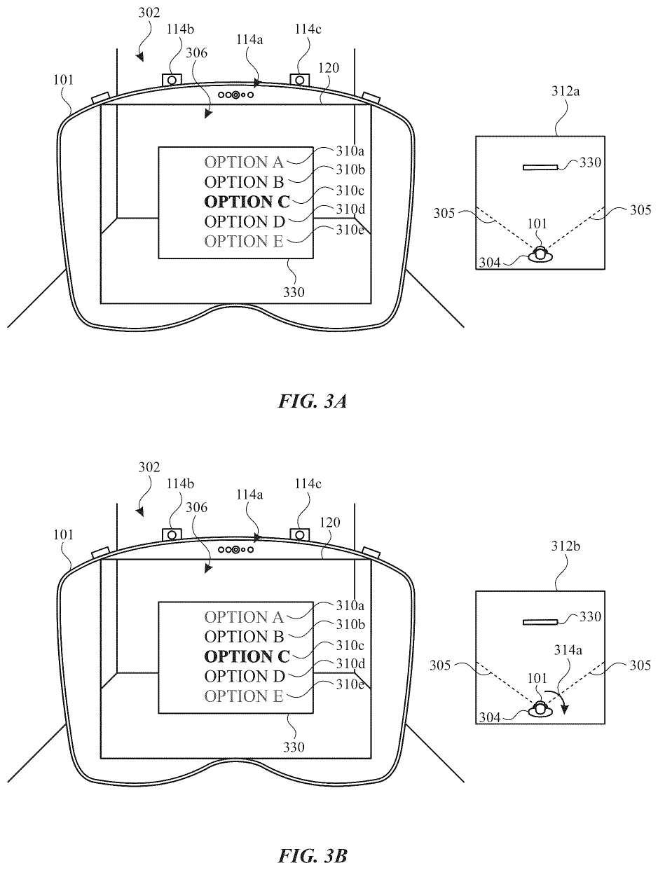

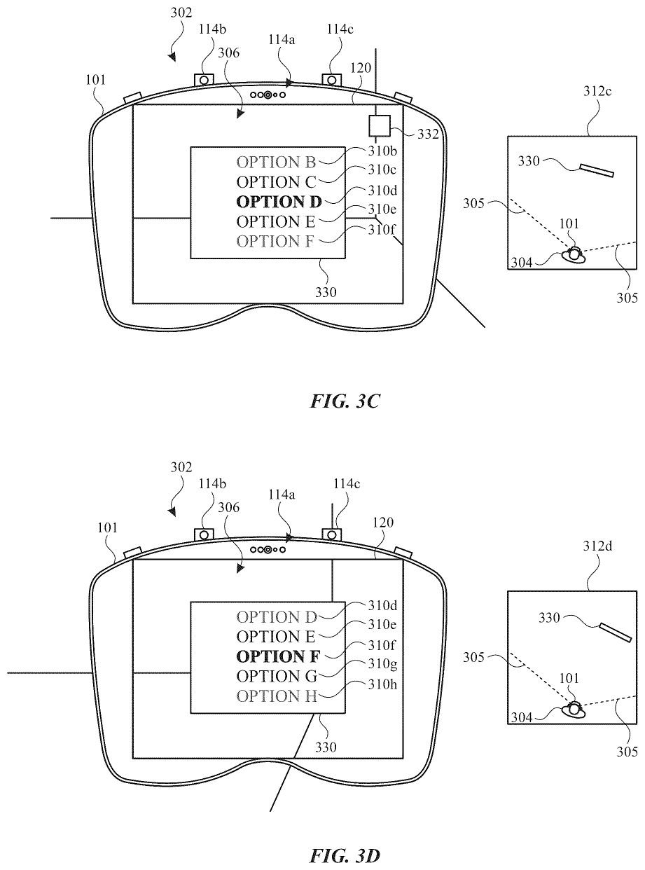

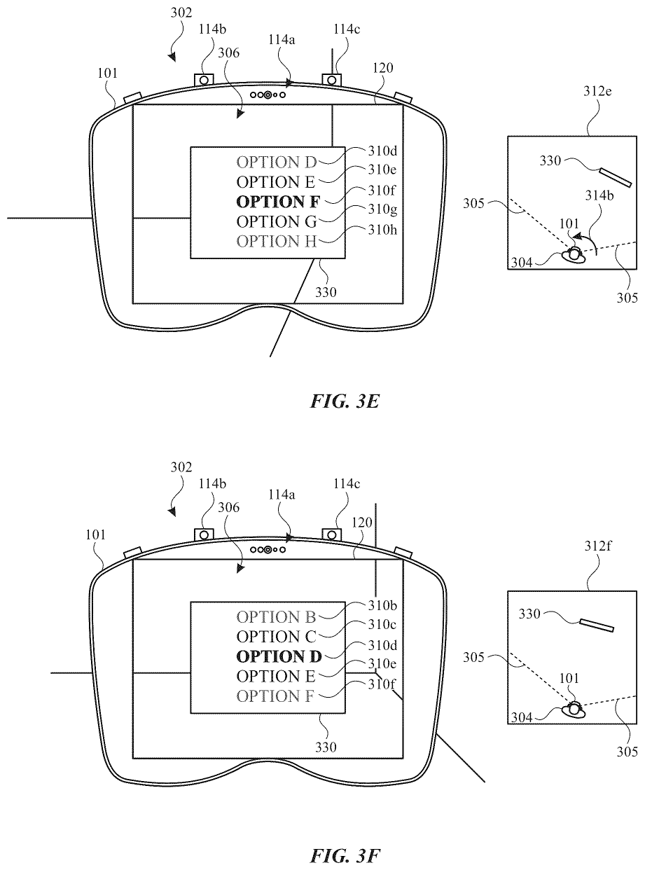

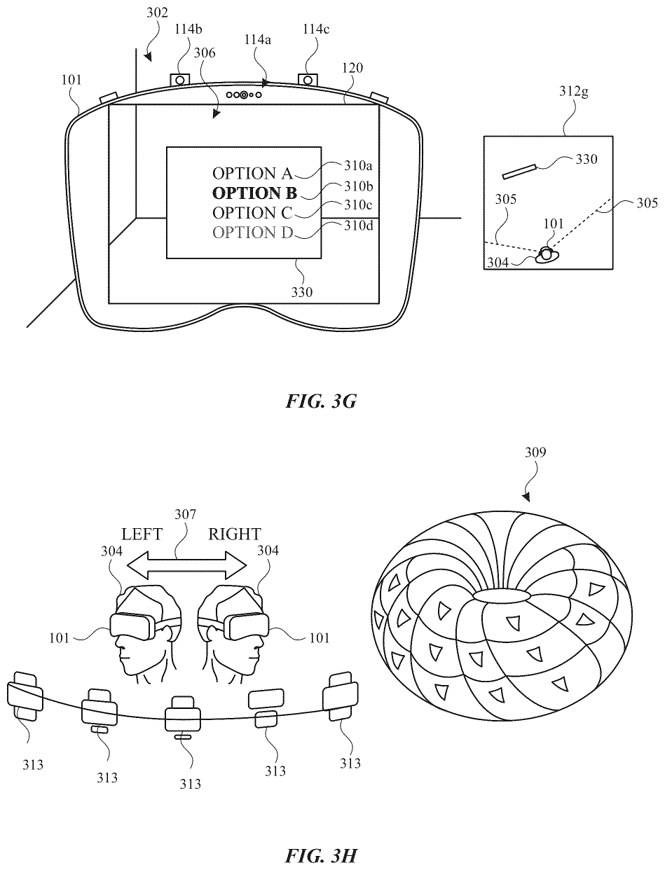

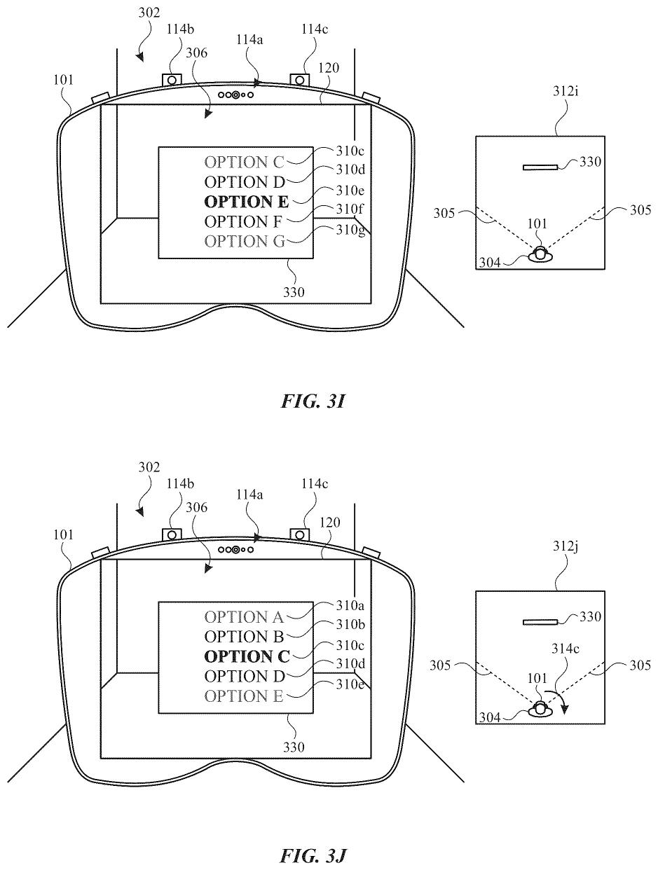

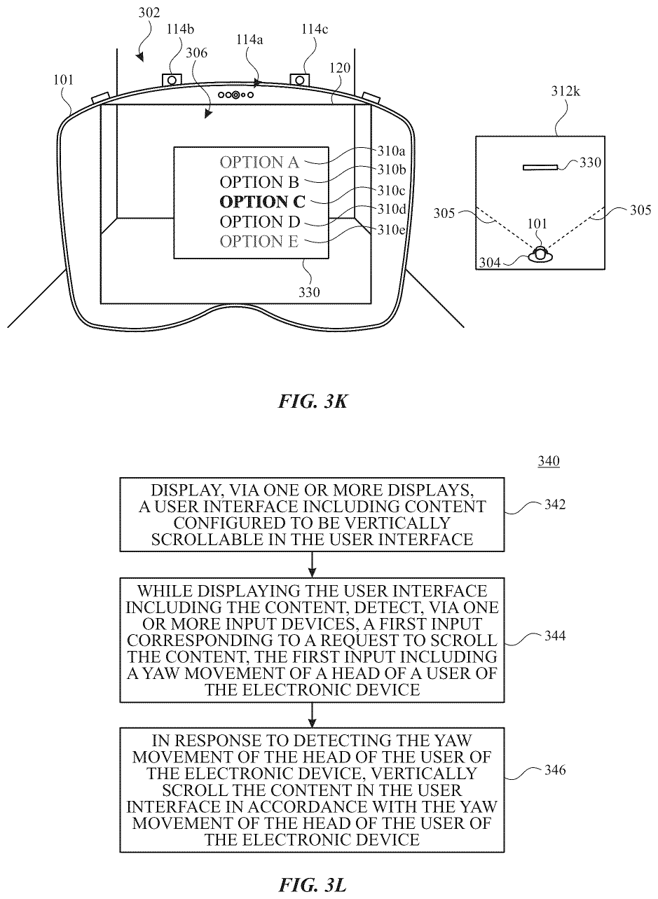

FIGS. 3A-3K generally illustrate an electronic device vertically scrolling content in a user interface in response to detecting yaw movements of a head of a user of the electronic device according to some examples of the disclosure.

For the purpose of illustration, FIGS. 3A-3G include respective top-down views 312a-312g and FIGS. 3I-3K include respective top-down views 312i-312k. These top-down views of an environment 306 (e.g., a three-dimensional environment) indicate the positions of various objects (e.g., real and/or virtual objects) in the environment 306 in a horizontal dimension and a depth dimension in the respective figure. The top-down view of the environment 306 further includes an indication of the viewpoint of the user 304 of the electronic device 101. For example, in FIG. 3A, the electronic device 101 displays the view of the environment 306 visible through the display 120 from the viewpoint of the user 304 illustrated in the top-down view 312a of the environment 306. Further, FIGS. 3A-3G and 3I-3K include viewing boundaries 305 of the user 304 of the electronic device 101 in the respective figure. For example, in FIG. 3A, the electronic device 101 displays the view of the environment 306 (e.g., the view that is bounded by the viewing boundaries 305 in the respective top-down view 312a) that is shown in the display 120 from the viewpoint of the user 304 illustrated in the top-down view 312a.

FIG. 3A shows a user 304 wearing an electronic device 101 in a physical environment 302, where the electronic device 101 is presenting environment 306 (e.g., a three-dimensional environment) through display 120 of electronic device 101. In some examples, environment 306 is an extended reality (XR) environment having one or more characteristics of an XR environment described above. For example, in FIG. 3A, display 120 of the electronic device 101 shows a user interface 330 and physical objects (e.g., edges of a physical room), which may be visible through display 120 (e.g., through video passthrough or optical see-through of the physical environment of user 304 that is visible to user 304 through display 120). In some examples, environment 306 is a virtual reality environment (e.g., environment 306 is fully or partially immersive (e.g., user 304 controls a level of immersion through one or more input devices of electronic device 101)).

FIG. 3A illustrates electronic device 101 displaying a user interface 330 in the environment 306. In FIG. 3A, user interface 330 is a list that includes a plurality of selectable options (e.g., the content illustrated by selectable options 310a-310e). In some examples, selectable options 310a-310e are a portion (e.g., subset) of a plurality of selectable options that are associated with user interface 330 (e.g., one or more selectable options of the plurality of selectable options are not currently visible/displayed in the environment 306 in FIG. 3A). In some examples, the plurality of selectable options associated with user interface 330 (e.g., selectable options 310a-310e shown in FIG. 3A) includes selectable content items, including text, photos, and/or media (e.g., music) that are selectable by user 304 (e.g., through a user input). In some examples, the plurality of selectable options associated with the user interface 330 (e.g., selectable options 310a-310e shown in FIG. 3A) are indicative of information without being further selectable.

In some examples, the user interface 330 is associated with a respective application (e.g., a media streaming application), and the plurality of selectable options include selectable content associated with the respective application. In some examples, user interface 330 is associated with a system user interface, and the plurality of selectable options are settings that are selectable and/or controllable by the user 304 in a menu of the system user interface. In some examples, the user interface 330 is arranged in the environment 306 in a world-locked orientation, body-locked orientation, a tilt-locked orientation, or head-locked orientation (e.g., including one or more characteristics of a world-locked orientation, body-locked orientation, tilt-locked orientation and/or head-locked orientation as described above).

In some examples, due to spatial constraints, only a portion of a plurality of selectable options associated with the user interface 330 is presented to the user 304 in the environment 306 at a given time (e.g., selectable options 310a-310e are a portion of the plurality of selectable options that is associated with user interface 330 as described above). In some examples, user interface 330 is scrollable to present one or more selectable options of the plurality of selectable options that are currently hidden to the user 304 (e.g., are not currently displayed) in the environment 306 in FIG. 3A.

In some examples, the user interface 330 corresponds to a bounded list. For example, when scrolling the user interface 330 in a first direction, a selectable option of the plurality of selectable options associated with the user interface 330 may correspond to a first bound, that, upon being scrolled unto while scrolling the user interface 330 in the first direction, causes the user interface 330 to no longer be scrollable in that first direction (e.g., as long as the first bound as reached). Continuing with this example, when scrolling the user interface 330 in a second direction (e.g., opposite from the first direction), a selectable option of the plurality of selectable options associated with the user interface 330 may correspond to a second bound of the bounded list, that, upon being scrolled unto while scrolling the user interface 330 in the second direction, causes the user interface 330 to no longer be scrollable in that second direction (e.g., as long as the second bound as reached).

In some examples, the user interface 330 corresponds to an unbounded list. For example, scrolling the user interface 330 includes cycling through the plurality of selectable options associated with user interface 330 without reaching a selectable option of the plurality of selectable options corresponding to a bound of the list (e.g., the user interface 330 is a carousel list). In some examples, scrolling the user interface 330 includes movement of the visible portion of the plurality of selectable options in one or more dimensions relative to environment 306. For example, scrolling the user interface 330 includes movement of the selectable options 310a-310e in a vertical dimension relative to the current viewpoint of user 304 in environment 306. For example, scrolling the user interface 330 includes movement of selectable options 310a-310e in a vertical dimension and a dimension of depth relative to the current viewpoint of user 304 in the environment 306 (e.g., the user interface 330 is a carousel list that is rotated in response to user input).

In some examples, scrolling the user interface 330 includes moving and/or replacing which selectable options of the plurality of selectable options are currently visible to the user 304 in the environment 306. In some examples, moving and/or replacing which selectable options of the plurality of selectable options are currently visible to the user 304 includes presenting an animation in the environment 306 that includes changing the visual prominence (e.g., opacity, brightness, color and/or size) of one or more selectable options as they are moved and/or replaced. Accordingly, different selectable options of the plurality of selectable options are presented with different amounts of visual prominence based on their relative position in the user interface 330. For example, as shown in FIG. 3A, the selectable option 310a and the selectable option 310e, which are presented at the top and bottom of the user interface 330, respectively, in the environment 306, are presented with less visual prominence compared to the selectable options 310b-310d (e.g., presenting selectable options 310a and 310e with less visual prominence informs the user 304 that the selectable options 310a and 310e do not have a current focus and that scrolling user interface 330 will cause selectable option 310a or selectable option 310e to cease to be presented in user interface 330). Further, as shown in FIG. 3A for example, the selectable option 310c is displayed with the greatest amount of visual prominence because it is in the focus region of the user interface 330, and the selectable option 310b and the selectable option 310d is displayed with an amount of visual prominence that is in between the visual prominences of the selectable options 310a and 310e and the selectable option 310c. In some examples, the selectable options 310a-310e appear to be presented with different amounts of visual prominence from the perspective of user 304 based on a distance of the selectable options 310a-310e (e.g., relative to a dimension of depth) from the current viewpoint of user 304 in the environment 306. For example, scrolling the user interface 330 includes movement of the selectable options 310a-310e in a vertical direction and a direction of depth relative to the current viewpoint of the user 304 in the environment 306 (e.g., as a respective selectable option of the plurality of selectable options is moved (e.g., during scrolling of the user interface 330) from a center of the user interface 330 toward the top or bottom of user interface 330, the respective selectable option is moved farther in depth relative to the current viewpoint of user 304 in environment 306). Accordingly, in some examples, selectable options 310a and 310e appear to have less visual prominence compared to selectable options 310b-310d from the perspective of user 304 because selectable options 310a and 310e are positioned in environment 306 at a greater distance from the current viewpoint of user 304 compared to selectable options 310b-310d.

As shown in FIG. 3A, selectable option 310c is presented at a center of user interface 330 and includes the greatest amount visual prominence (e.g., selectable option 310c is displayed with a greater amount of opacity, brightness, color and/or size (e.g., with bolder font) compared to selectable options 310a-310b and 310d-310e) compared to the plurality of selectable options currently visible in environment 306. In some examples, presenting selectable option 310c with the greatest amount of visual prominence visually indicates to user 304 that selectable option 310c has a current focus (e.g., presenting selectable option 310c with a greater amount of visual prominence compared to different selectable options included in user interface 330 informs user 304 that selectable option 310c is the option of the plurality of selectable options that would be selected in response to a selection input (e.g., an air pinch or tap gesture) provided by user 304). In some examples, in response to scrolling user interface 330, selectable option 310c is replaced as the selectable option with the current focus of the plurality of selectable options associated with user interface 330.

The user interface 330 is vertically scrollable. As such, the plurality of selectable options is scrollable such that they might have different vertical placements in the user interface 330 in response to a scroll input. In some examples, the electronic device 101 vertically scrolls the content of the user interface 330 in response to detecting a yaw movement of the head of the user of the electronic device 101, such as shown in FIGS. 3A through 3C.

For example, while displaying the user interface 330 as in FIG. 3A, the electronic device 101 may detect a yaw movement of the head of the user of the electronic device, such as shown with arrow 314a in FIG. 3B being a clockwise rotation of the head of the user 304. In response, the electronic device 101 may scroll the content of the user interface 330, as shown in FIGS. 3B through 3D, in accordance with the detected yaw movement (e.g., based on the amount of detected yaw movement).

In some examples, FIG. 3C and FIG. 3D illustrate example results of the electronic device 101 vertically scrolling the user interface by different amounts in accordance with different amount of detected yaw movements. For instance, in some examples, the arrow 314a of FIG. 3B is yaw movement of a first amount, and in response to detecting the first amount of yaw movement in FIG. 3B, the electronic device 101 vertically scrolls the content of the user interface 330 by a first respective amount, as shown from FIG. 3B to FIG. 3C. Continuing with this instance, alternatively, in some examples, the arrow 314a of FIG. 3B is yaw movement of a second amount that is greater than the first amount, and in response to detecting the second amount of yaw movement in FIG. 3B, the electronic device 101 vertically scrolls the content of the user interface 330 by a second respective amount that is greater than the first respective amount, as shown from FIG. 3B to FIG. 3D with the amount of vertically scrolling illustrated from FIG. 3B to FIG. 3D being greater than the amount of vertical scrolling illustrated from FIG. 3B to FIG. 3C. As such, in some examples, the electronic device 101 may scroll through content of the user interface by different amounts in response to detecting different amounts of yaw movements.

In some examples, FIG. 3C and FIG. 3D illustrate example results of the electronic device 101 vertically scrolling the user interface 330 in response to a single yaw movement (e.g., a continuous yaw movement in a first rotation direction). For example, the amount of vertically scrolling illustrated from FIG. 3B to FIG. 3C may be the result of detection of a first part of a yaw movement. Continuing with this example, the electronic device 101 may further vertically scroll the content of the user interface 330, as shown from FIG. 3C to FIG. 3D in response to detecting a second part of the single yaw movement (e.g., continuous yaw movement in the first rotation direction). As such, in some examples the electronic device 101 may scroll through the content of the user interface, including scrolling through a plurality of intermediate locations of the content until a final position is reached in the content that corresponds to an ending of the yaw movement of the head of the user of the electronic device 101.

Additionally, note that from FIG. 3B to FIGS. 3C and 3D, the user interface 330 behaves as a head-locked object, such as described above, so the user interface 330 is moved in the environment 306 in accordance with the detected head movement of the user 304. Since the illustrated head movement from FIG. 3B to FIGS. 3C and 3D is solely yaw movement of the head of the user, the electronic device 101 moves the user interface 330 in accordance with the yaw movement of the head of the user. Note that were the electronic device 101 to detect movement of the head of the user that includes yaw movement and pitch movement, the electronic device 101 may respond by moving the user interface 330 in the environment 306 in accordance with both the yaw movement and the pitch movement and by vertically scrolling the content of the user interface 330 in accordance with the yaw movement (e.g., independent of the pitch movement). Note that were the electronic device 101 to detect pitch movement of the head of the user without detecting yaw movement of the head of the user, the electronic device 101 may respond by moving the user interface 330 in the environment 306 in accordance with the pitch movement, without vertically scrolling the content of the user interface 330.

Further, note that in some examples, in response to the electronic device 101 entering a mode that corresponds certain yaw movements of the head of the user as requests to scroll, the electronic device 101 presents an indication (e.g., a notification) that yaw movement of the user may result in scrolling of the content of the user interface 330, such as indication 332 in FIG. 3C. In some examples, indication 332 is a visual indication, an audio indication, and/or another type of haptic indication. As such, the electronic device 101 may present an indication to the user 304 that notifies the user 304 that yaw movements of the user may result in scrolling of the content of the user interface 330.

In some examples, the electronic device 101 scrolls the content of the user interface 330 in different directions based on a direction of the yaw movement of the head of the user 304. For instance, FIGS. 3C and 3D illustrate examples of the electronic device 101 vertically scrolling down the content of the user interface 330 in accordance with yaw movement that is in a first direction, which is clockwise movement from the perspective of the top down view 312b in FIG. 3B, as shown with the direction of arrow 314a in the top down view 312b in FIG. 3B. FIGS. 3E-3G illustrate examples of the electronic device 101 detecting and responding to yaw movement of the head of the user 304 that is in a second direction that is different from (e.g., opposite) the first direction. In FIG. 3E, while displaying user interface 330, the electronic device 101 detects a yaw movement of the head of the user, which is counterclockwise movement from the perspective of the top down view 312e, as shown with the direction of arrow 314b in the top down view 312e in FIG. 3E. In response, the electronic device 101 vertically scrolls up the content of the user interface 330, as shown from FIG. 3E to FIG. 3F. In some examples, the arrow 314b in FIG. 3E corresponds to a first amount of yaw movement, and in response to detecting the first amount of yaw movement, the electronic device 101 scrolls up the content of the user interface 330 by a first respective amount, as shown from FIG. 3E to FIG. 3F. In some examples, the arrow 314b in FIG. 3E corresponds to a second amount of yaw movement that is greater than the first amount of yaw movement, and in response to detecting the second amount of yaw movement, the electronic device 101 scrolls up the content of the user interface 330 by a second respective amount that is greater than the first respective amount, as shown from FIG. 3E to FIG. 3G with the amount of vertically scrolling illustrated in the user interface 330 from FIG. 3E to FIG. 3G being greater than the amount of vertical scrolling illustrated in the user interface 330 from FIG. 3E to FIG. 3F.

In some examples, FIG. 3F and FIG. 3G illustrate example results of the electronic device 101 vertically scrolling the user interface 330 in response to a single yaw movement (e.g., a continuous yaw movement in a rotation direction). For example, the amount of vertically scrolling illustrated from FIG. 3E to 3F may be the result of detection of a first part of a continuous yaw movement in a first direction. Continuing with this example, the electronic device 101 may further vertically scroll the content of the user interface 330, as shown from FIG. 3F to FIG. 3G, in response to detecting a second part of the continuous yaw movement in the first direction.

FIG. 3H illustrates an example schematic of an electronic device 101 scrolling content of a user interface, such as the user interface 330, that is a head-locked object. In some examples, as described above, the content of the user interface 330 is arranged as a carousel, such as a vertical carousel. For example, the plurality of selectable options may include six selectable options (e.g., selectable option 310a-310f), where each option may be placed on a respective shelf of the vertical carousel. As a carousel, were the user interface 330 to display a first selectable option having a first orientation on the carousel in the viewpoint of the user 304 (e.g., from the viewpoint of the user 304) when a request to scroll the carousel in a first direction is detected, in response to the scrolling in the first direction, the first selectable option would have different intermediate orientations on the carousel in the viewpoint of the user 304 in accordance with the scrolling in the first direction, and may again have the first orientation on the carousel in the viewpoint of the user (e.g., provided that the scrolling input results in a 360 degree rotation of the first selectable option). As such, as a carousel, it could be scrolled in a first direction to any selectable option, independent of the orientation of the selectable option when the scrolling input is detected. In an example, as a carousel, when the user interface 330 includes six selectable options, the user interface may behave as a hexagonal prism with the hexagonal bases facing lateral directions in the viewpoint of the user, and with each selectable option having a respective rectangular lateral face of the hexagonal prism. For example, in response to a scrolling input (e.g., in response to detecting a yaw movement of the user), the rectangular lateral faces of the hexagonal prism may rotate about the center axis extending through each hexagonal base of the hexagonal prism, such as the top-most rectangular lateral face rotating toward the user and the bottom-most rectangular lateral face rotating away from the user, thus scrolling the selectable options. Were the user interface 330 to also be head-locked, as described with reference to FIGS. 3B-3G, in response to detecting yaw movement of the head of the user, the electronic device 101 would move the user interface 330 in the environment 306 in accordance with the yaw movement, such as shown with the movement of the user interface 330 in FIGS. 3B-3G. Thus, the resulting movement of the selectable options, would be rotational movement about a vertical axis of the user interface 330 and movement about the yaw axis of the head of the user 304, which, taken together, mimics a spiraling movement of a respective selectable option in the environment 306, such as shown with the spiraling 309 and/or movement of the selectable option 313 (e.g., in an environment) as a function of the yaw movement 307 (e.g., to the right or to the left) illustrated in FIG. 3H. As such, in some examples, as the user interface 330 is scrolled in response to yaw movement (e.g., the yaw movement 307 to the left or to the right), a selectable option of the user interface 330 is moved in the environment 306 both vertically in the user interface 330 and rotationally about a vertical axis, such as the yaw axis of the head of the user 304.

In some examples, user interface 330 is a world-locked object, such as described herein with reference to an object having a world-locked orientation. FIGS. 3B and 3I illustrate an example of the electronic device 101 scrolling the content of the user interface 330 when the user interface 330 is world-locked. As shown from FIG. 3B to 3I, the electronic device 101 has scrolled the content of the user interface 330 in response to the detected yaw movement of FIG. 3B, while maintaining the position of the user interface 330 in the environment 306. That is, the position of the user interface 330 in the environment 306 has not moved from FIG. 3B to FIG. 3I. As such, in some examples, the electronic device 101 scrolls the content of the user interface 330 in response to detecting yaw movements of the head of the user 304 even if the user interface 330 is a world-locked object.

Note that in some examples, were the electronic device 101 to detect a yaw movement of the head of the user that meets one or more first criteria, the electronic device 101 may respond by scrolling the content of the user interface 330 in accordance with the yaw movement. For example, the yaw movements described with reference to arrows 314a and 314b may meet the first criteria, and as such, the electronic device 101 responds by scrolling the content of the user interface 330. Were the electronic device 101 to detect a yaw movement of the head of the user that does not satisfy the first criteria, the electronic device 101 may respond by forgoing scrolling the content of the user interface 330, such as shown in FIGS. 3J and 3K. For example, in FIG. 3J, which includes display of user interface 330 as in FIG. 3A, the electronic device 101 detects a yaw movement of the head of the user 304 that does not satisfy the first criteria, as shown with arrow 314c in FIG. 3J. In response, the electronic device 101 forgoes scrolling the content of the user interface 330 as shown from FIG. 3J to FIG. 3K. In some examples, the first criteria include the yaw movement being more than a threshold amount (e.g., 0.5, 1, 2, 3, 4 degrees, or another amount) of yaw movement. Additionally or alternatively, the first criteria include the yaw movement being performed within a threshold amount of time (e.g., such that the average angular speed of the yaw movement is greater than a threshold angular speed).

Further, note that the amount of scrolling of the content of the user interface 330 may be based on an average amount of yaw movement of the head of the user over a period of time. For example, were the average amount of yaw movement a first amount of yaw movement over a first period of time (e.g., 0.5 s, 1 s, 2 s, 5 s, 10 s, or another period of time), the electronic device 101 may scroll the content of the user interface 330 by a first amount. Continuing with this example, were the average amount of yaw movement a second amount of yaw movement over the first period of time, where the second amount of yaw movement is greater than the first amount of yaw movement, the electronic device 101 may scroll the content of the user interface 330 by a second amount that is greater than the first amount (e.g., that is different from the first amount).

In addition, note that in some examples, the electronic device 101 scrolls the content of the user interface 330 at a scroll speed that is based on an angular velocity associated with the yaw movement of the head of the user. For example, in accordance with a determination that the angular velocity associated with the yaw movement is a first angular velocity, the electronic device may vertically scroll the content of the user interface 330 at a first scroll rate. Continuing with this example, in accordance with a determination that the angular velocity associated with the yaw movement is a second angular velocity, which is different from the first angular velocity, the electronic device 101 may vertically scroll content of the user interface 330 at a second scroll rate that is different from the first scroll rate. In some examples, the faster the angular velocity associated with a yaw movement of a head of user, the faster the scrolling that the electronic device performs in response to that yaw movement. As such, in some examples, the electronic device 101 scrolls the content of the user interface at a scrolling rate that is based on an angular velocity of the yaw movement of the head of the user. Further, in some examples, the electronic device scrolls the content of the user interface 330 at a threshold minimum scroll rate. In some examples, the electronic device scrolls the content of the user interface 330 at a threshold maximum scroll rate. In some examples, after scrolling the content of the user interface 330 by a first amount, were no yaw movement of the head of the user that satisfies one or more first criteria (e.g., such as a criterion that is satisfied when yaw movement is above a threshold amount of yaw movement in a first direction within period of time) to be detected, the electronic device 101 may cease scrolling the content of the user interface 330.

FIGS. 3A-3K are further described with reference to method 340 in FIG. 3L. FIG. 3L generally illustrates a method for vertically scrolling content in a user interface in response to detecting yaw movement of a head of a user of the electronic device according to some examples of the disclosure. FIG. 3L is a flow diagram illustrating the method 340 for vertically scrolling content in a user interface in response to detecting yaw movement of a head of a user of the electronic device according to some examples of the disclosure. It is understood that method 340 is an example and that more, fewer, or different operations can be performed in the same or in a different order. Additionally, the operations in method 340 described below are, optionally, implemented by running one or more functional modules in an information processing apparatus such as general-purpose processors (e.g., as described with respect to FIGS. 2A-2B) or application specific chips, and/or by other components of FIGS. 2A-2B.

Therefore, according to the above, some examples of the disclosure are directed to a method (e.g., method 340 of FIG. 3L) performed at an electronic device (e.g., the electronic device 101) in communication with one or more displays and one or more input devices. The method 340 includes displaying (342), via the one or more displays, a user interface including content configured to be vertically scrollable in the user interface. The method 340 while displaying the user interface including the content, detecting (344), via the one or more input devices, a first input corresponding to a request to scroll the content, the first input including a yaw movement of a head of a user of the electronic device. The method 340 includes in response to detecting the yaw movement of the head of the user of the electronic device, vertically scrolling (346) the content in the user interface in accordance with the yaw movement of the head of the user of the electronic device.

Additionally or alternatively, in some examples, the yaw movement of the head of the user is more than a threshold amount of yaw movement of the head of the user, and the method 340 includes while displaying the user interface including the content and before detecting the first input (or optionally otherwise while not detecting the first input), detecting, via the one or more input devices, a first respective amount of yaw movement of the head of the user that is less than the threshold amount of yaw movement of the head of the user, and in response to detecting the first respective amount of yaw movement, forgoing scrolling the content. Additionally or alternatively, in some examples, the threshold amount of yaw movement is further associated with an amount of yaw movement of the head of the user over a period of time, the yaw movement is performed within the period of time, and the first respective amount of yaw movement is performed over more than the period of time.

Additionally or alternatively, in some examples, vertically scrolling the content in the user interface in accordance with the yaw movement of the head of the user of the electronic device includes vertically scrolling the content by an amount that is based on an average amount of movement of the head of the user over a period of time. For example, were the average amount of movement of the head of the user over the period of time a first amount of movement, the electronic device 101 may vertically scroll the content by a first amount of vertical scrolling. Continuing with this example, were the average amount of movement of the head of the user over the period of time a second amount of movement that is different from the first amount of movement, the electronic device 101 may vertically scroll the content by a second amount that is different from the first amount of vertical scrolling. In some examples, the greater the average amount of movement of the head of the user over the period of time, the greater the resulting vertical scrolling of the content.

Additionally or alternatively, in some examples, the method 340 includes in response to detecting the first input, presenting an indication to the user of the electronic device that the content is scrollable in response to a respective yaw movement of the head of the user of the electronic device.

Additionally or alternatively, in some examples, the method 340 includes in accordance with a determination that the yaw movement of the head of the user of the electronic device is in a first rotation direction, such as the direction indicated by the arrow 314b in FIG. 3E vertically scrolling the content in a first vertical direction of the user interface, such as shown with the upward scrolling of the content of the user interface 330 from FIG. 3E to FIG. 3F, and in accordance with a determination that the yaw movement of the head of the user of the electronic device is in a second rotation direction, different from the first rotation direction, vertically scrolling the content in a second vertical direction of the user interface that is different from the first vertical direction of the user interface. For example, while displaying the content of the user interface 330 of FIG. 3E, if the electronic device 101 detects yaw movement of the head of the user of the electronic device 101 in the direction indicated by the arrow 314c in FIG. 3J, which is different from (e.g., opposite) the direction indicated by the arrow 314b in FIG. 3E, the electronic device 101 would vertically scroll the content downward, which would be different from (e.g., opposite) the direction of scrolling of the content of the user interface 330 illustrated from FIG. 3E to FIG. 3F. In some examples, the second vertical direction is the inverse direction around the same axis as the first vertical direction.

Additionally or alternatively, in some examples, the method 340 includes in accordance with a determination that the yaw movement of the head of the user of the electronic device is a first amount of rotation in the first rotation direction, vertically scrolling the content in the first vertical direction by a first scrolling amount and in accordance with a determination that the yaw movement of the head of the user of the electronic device is a second amount of rotation in the first rotation direction that is different from the first amount of rotation in the first rotation direction, vertically scrolling the content in the first vertical direction by a second scrolling amount that is different from the first scrolling amount.

Additionally or alternatively, in some examples, when the first input is detected, the user interface is displayed at a first location in a three-dimensional environment, and the method 340 includes in response to detecting the yaw movement of the head of the user of the electronic device, moving the user interface to a second location in the three-dimensional environment that is different from the first location.

Additionally or alternatively, in some examples, when the first input is detected, the user interface is displayed at a first location in a three-dimensional environment, and the method 340 includes in response to detecting the yaw movement of the head of the user of the electronic device, maintaining display of the user interface at the first location in three-dimensional environment.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

Attention is now generally directed towards examples of an electronic device detecting and responding to inputs that corresponds to request to display one or more user interface elements, where the inputs include head rotations of a user of the electronic device according to some examples of the disclosure.

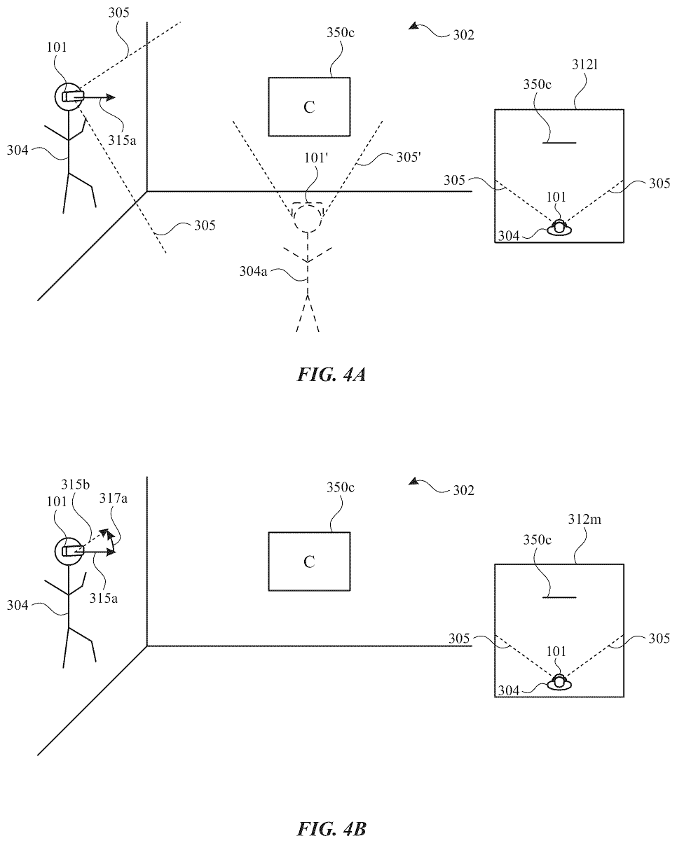

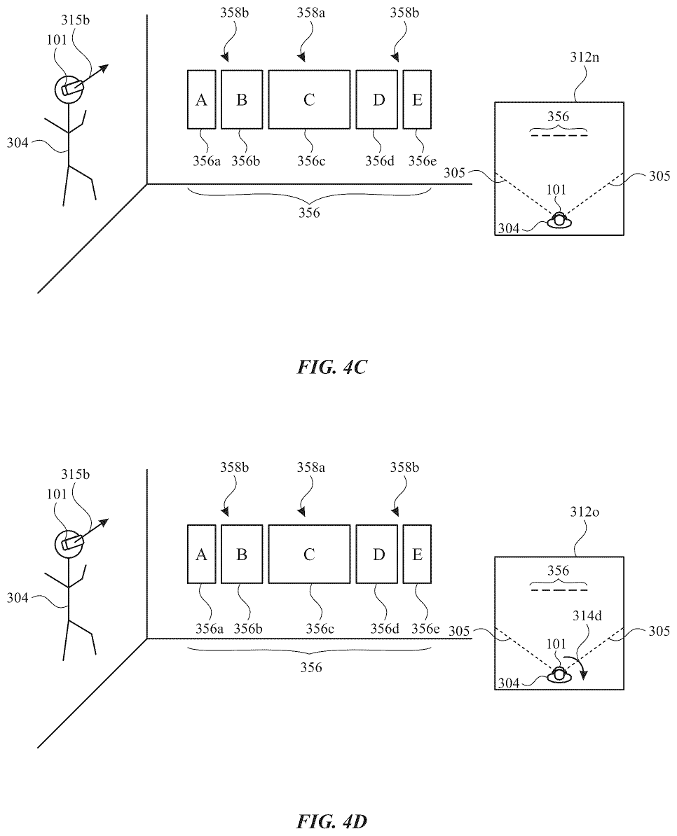

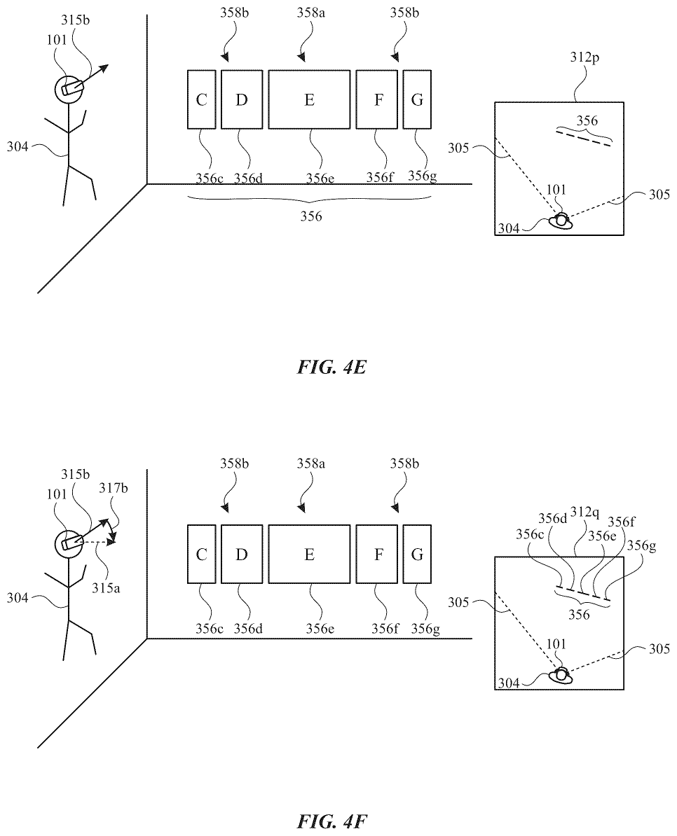

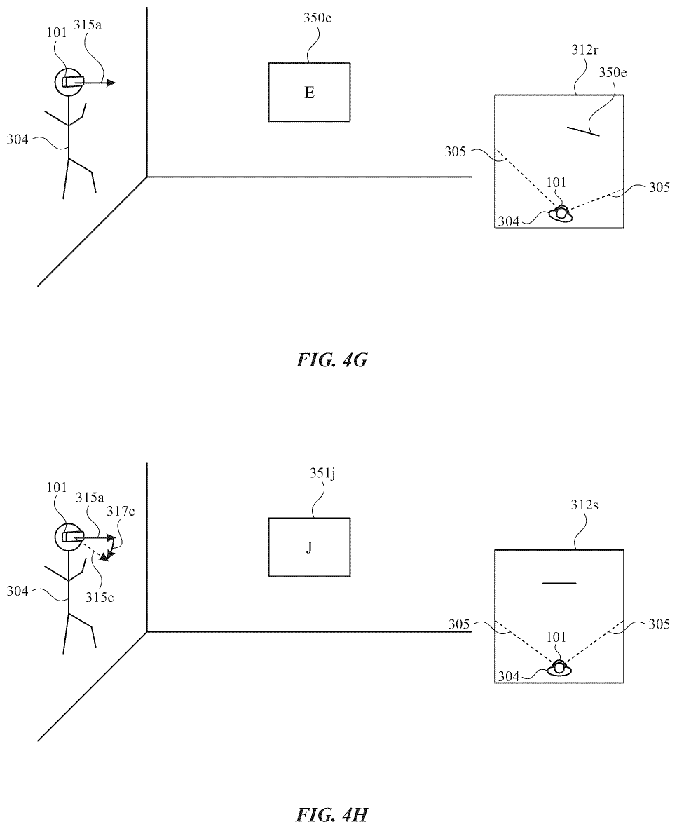

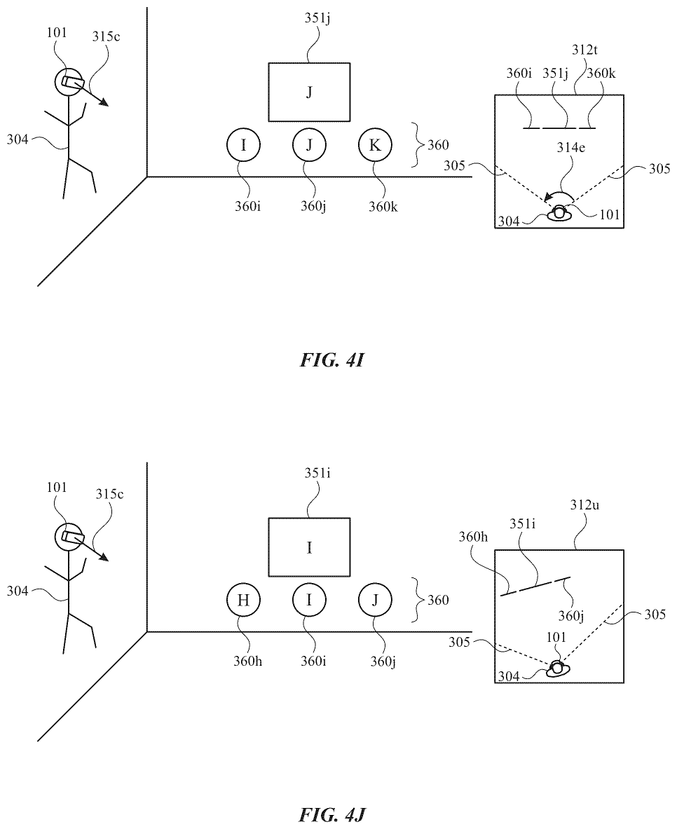

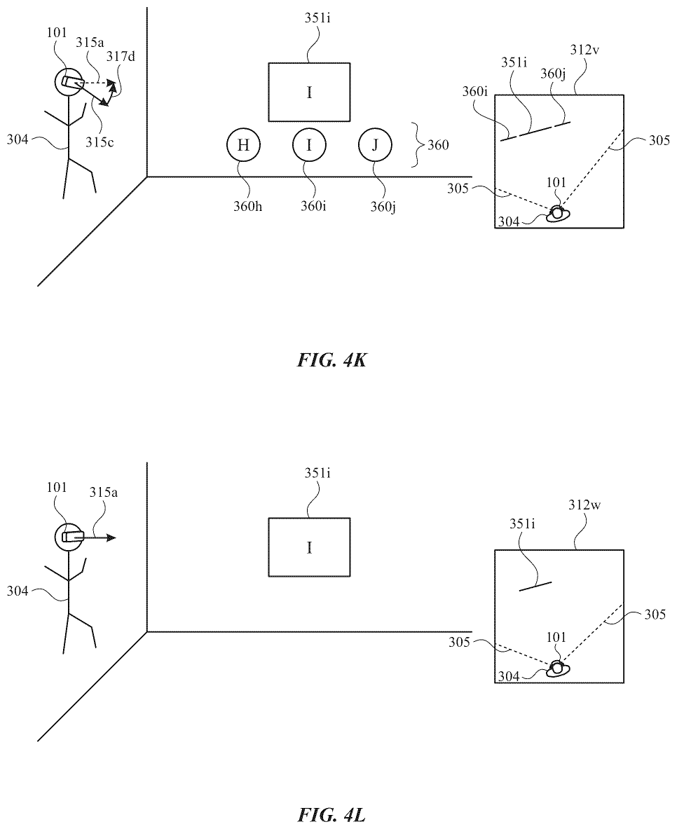

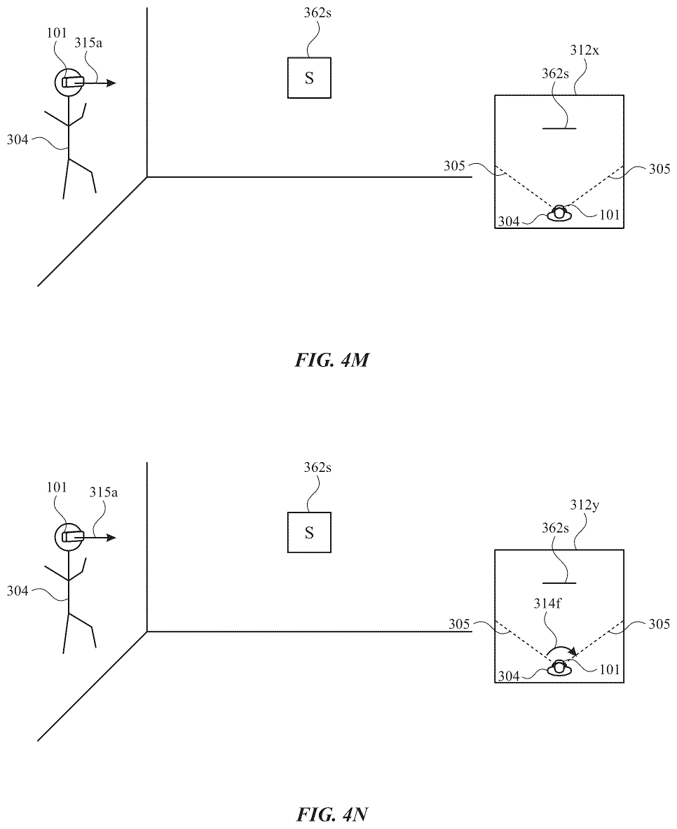

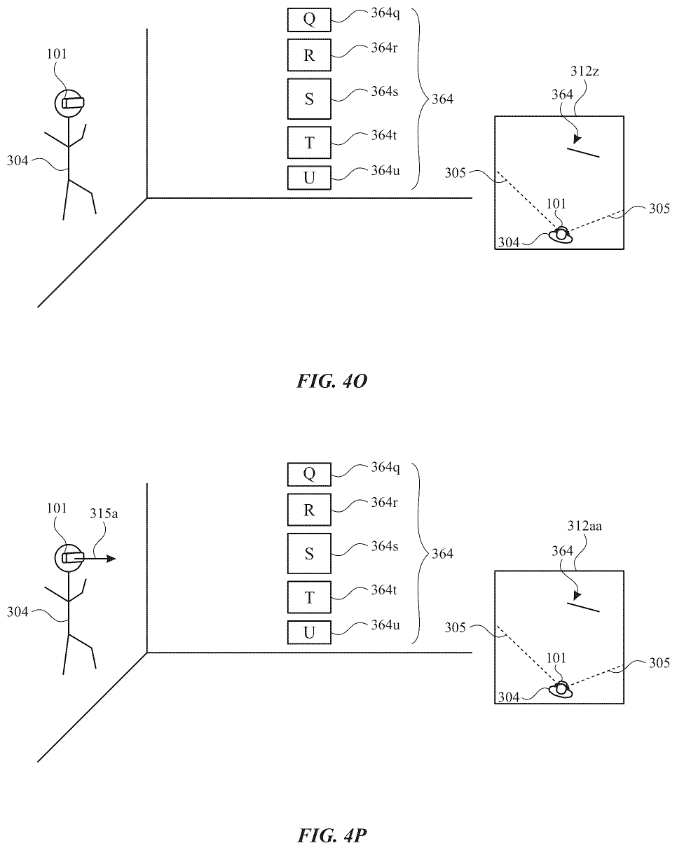

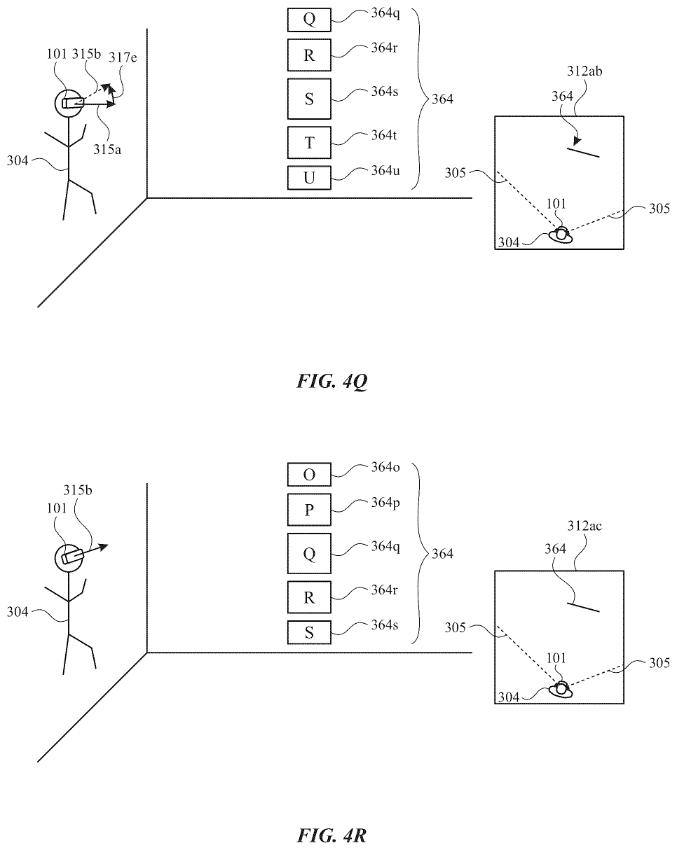

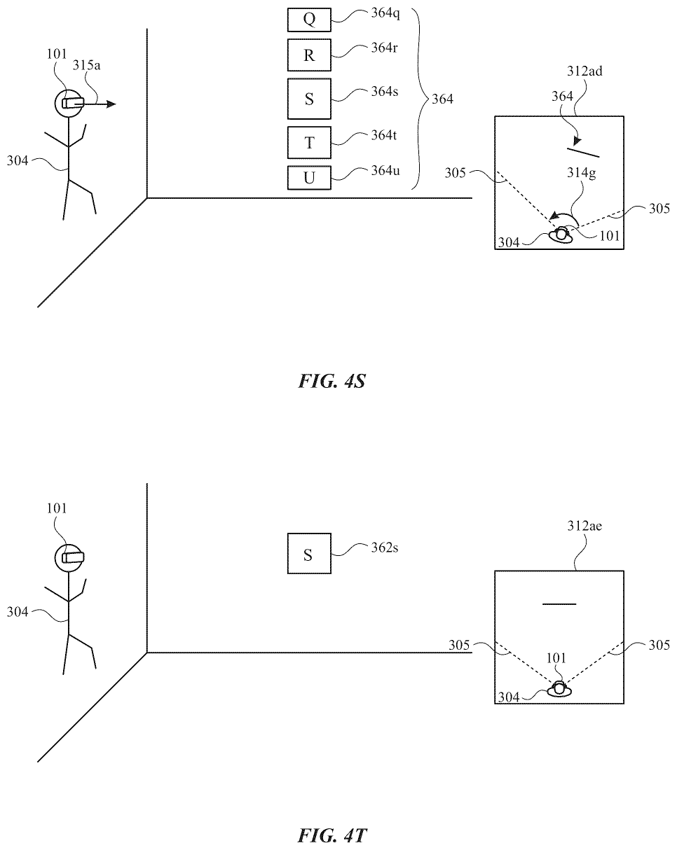

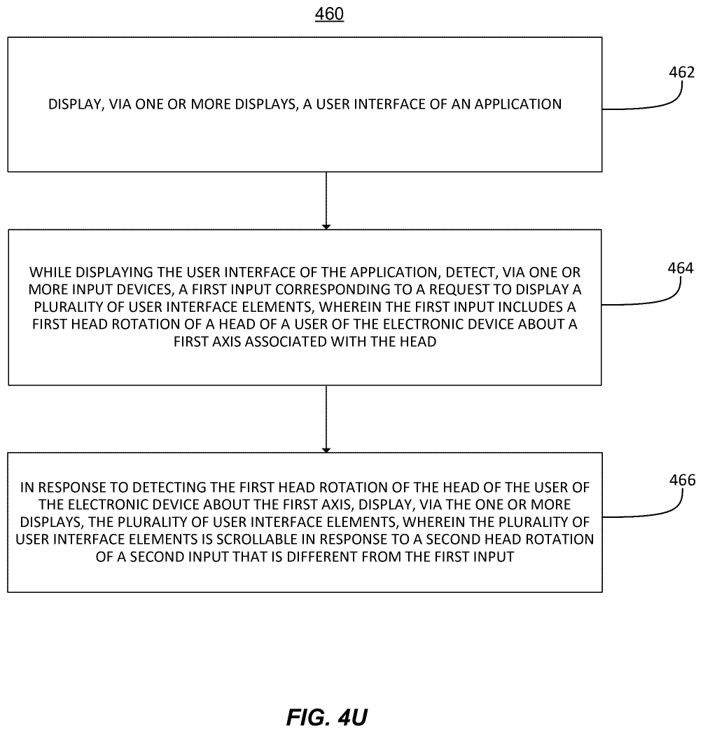

In some examples, the electronic device 101 detects a head movement of the user about an axis associated with the head of the user, and in response, displays a plurality of selectable options that is paginated for scrolling about an axis that corresponds to an axis that is perpendicular to the axis associated with the head of the user. Such features are generally illustrated in FIGS. 4A-4T and are further described with reference to method 450 of FIG. 4U.

FIGS. 4A-4T generally illustrate an electronic device 101 detecting and responding to inputs that corresponds to request to display one or more user interface elements (e.g., a plurality of selectable options), where the inputs include head rotations of a user of the electronic device according to some examples of the disclosure.

For the purpose of illustration, FIGS. 4A-4T include respective perspective views and respective top-down views 312l-312ae. The respective perspective views are generally provided to illustrate certain head movements, such as pitch movements of the head of the user. The top-down views 312l-312ae of the respective figures generally illustrate the spatial arrangement between the user 304 and the user interfaces and/or user interface elements displayed in the respective figure. That is, for example, in FIG. 4A, as shown in top-down view 312l, the electronic device 101 is displaying the user interface 350c facing the user 304.

In addition, the top-down views 312l-312ae indicate the positions of various objects (e.g., real and/or virtual objects) in visible the display of the electronic device 101 in a horizontal dimension and a depth dimension in the respective figure. The top-down view further includes an indication of the viewpoint of the user 304 of the electronic device 101. For example, in FIG. 4A, the electronic device 101 displays a view (e.g., of a three-dimensional environment) visible through the display of the electronic device 101 from the viewpoint of the user 304 illustrated in the top-down view 312l.

Further, in FIG. 4A, the spatial arrangement between the user 304 and the user interface 350c (e.g., the more accurate spatial arrangement in the environment) is the spatial arrangement illustrated between the representation 304a of the user 304 and the user interface 350c in the perspective view. That is, in FIG. 4A, the electronic device 101′ (e.g., which is representative of the electronic device 101) is displaying the user interface 350c in an orientation that faces the user 304 (e.g., in the viewing boundaries 305′ of the representation 304 of the user), such as shown with spatial arrangement between the representation 304a of the user 304 and the user interface 350c, and the top-down view likewise illustrates that spatial arrangement in a depth dimension and a horizontal dimension. Thus, note that the position of the user 304 (e.g., relative the user interface in the respective figure) in FIGS. 4A-4T is different in the perspective view versus the top down view of the respective figure for ease of illustration of certain head movements (e.g., pitch head movements) described with reference to the figures. Further, FIGS. 4A-4T include viewing boundaries 305 of the user 304 of the electronic device 101 in the respective figure. For example, in FIG. 4A, the electronic device 101 displays a view of (e.g., of a three-dimensional environment) that is bounded by the viewing boundaries 305 in the respective top-down view 312l that is shown in the display 120 from the viewpoint of the user 304 illustrated in the top-down view 312a. In FIG. 4A, the perspective view also includes viewing boundaries 305 in a vertical and depth dimension, and the viewing boundaries 305 may move relative to the physical environment of the user 304 were the head of the user 304 to move. For example, viewing boundaries in FIG. 4B may have the same spatial arrangement relative to the arrow 315b of FIG. 4C, which indicates a forward-facing head direction of the user 304 in the figure, as the viewing boundaries 305 of FIG. 4A relative to the arrow 315a of FIG. 4A, which likewise indicates a forward-facing head direction of the user 304 in the figure.

In FIG. 4A, the electronic device 101 displays a user interface 350c in the environment 306. In some examples, the user interface 350c includes one or more characteristics of the user interface 330 described with reference to FIGS. 3A-3L. For example, the user interface 350c may be associated with a respective application (e.g., a messaging application, a media streaming application, or another type of application). In some examples, the electronic device 101 displays a scrollable plurality of user interface elements in response to detecting particular head movements of the user 304 of the electronic device 101, such as shown in FIGS. 4A-4C.

For example, in FIG. 4B, which includes display of the user interface 350c as in FIG. 4A, the electronic device 101 detects a head movement of the user of the electronic device 101. In FIG. 4B, the head movement is an upward pitch movement of the head of the user, as shown with arrow 317a in FIG. 4B being a counterclockwise rotation of the head of the user 304 (e.g., rotating about the pitch axis of the head of the user 304) from the head orientation indicated by the arrow 315a to the head orientation indication by the arrow 315b. In some examples, the electronic device 101 of FIG. 4B interprets upward pitch movements as requests to display a plurality of selectable options. For example, were the head movement of FIG. 4B not an upward pitch movement, the electronic device 101 may not interpret such movement as a request to display a plurality of selectable options. In response to detecting the upward pitch movement of the head of the user 304 in FIG. 4B, the electronic device 101 may display a plurality of selectable options 356, as shown from FIG. 4B to FIG. 4C.

In some examples, the plurality of selectable options 356 correspond to different user interfaces of different applications (e.g., a music application, movie application, Internet application, etc.). For example, selectable option 356a may correspond to a first user interface of a first application, selectable option 356b may correspond to a second user interface of a second application, selectable option 356c may correspond to a third user interface of a third application, selectable option 356d may correspond to a fourth user interface of a fourth application, and selectable option 356e may corresponds to a fifth user interface of a fifth application.

In some examples, the plurality of selectable options 356 correspond to different user interfaces of the same application (e.g., of an Internet application, a media application, a word processing application, an email application, a gaming application, or another application). For example, the application of the user interfaces may be an Internet application, with each selectable option of the plurality of selectable options 356 corresponding to a different page (e.g., window) of the Internet application. For example, selectable option 356a may correspond to a first window of the Internet application, selectable option 356b may correspond to a second window of the Internet application, selectable option 356c may correspond to a third window of the Internet application, selectable option 356d may correspond to a fourth window of the Internet application, and selectable option 356e may correspond to a fifth window of the Internet application. In some examples, the plurality of selectable options 356 may include one or more characteristics of the selectable options 310a-310e. In some examples, the selectable options 356a-356e in FIG. 4C are a subset of a plurality of selectable options 356, and the other selectable options that are not shown in FIG. 4C may be displayed in response to a scroll input.

The plurality of selectable options 356 of FIG. 4C are horizontally scrollable. As such, FIGS. 4A through 4C illustrate examples of an electronic device 101 displaying content that is scrollable in a direction that corresponds to a direction that is perpendicular to an axis of rotation of the head movement that resulted in the electronic device 101 displaying the plurality of selectable options. For example, in FIG. 4B, the electronic device 101 detects a head movement that is about the pitch axis of the user 304, and in response the electronic device 101 displays the plurality of selectable options 356 that are horizontally paginated, as shown in FIG. 4C.

FIGS. 4D and 4E illustrate the electronic device 101 detecting and responding to a request to scroll the plurality of selectable options 356. In FIG. 4D, while displaying the plurality of selectable options 356 as in FIG. 4C, the electronic device 101 detects a yaw movement of the head of the user of the electronic device 101, as shown with arrow 314d in the top down view 312o in FIG. 4D being a clockwise rotation of the head of the user 304. In response, the electronic device 101 horizontally scrolls the plurality of selectable options 356, as shown from FIG. 4D to FIG. 4E. Note that the scrolling illustrated from FIG. 4D to FIG. 4E is a horizontal scroll that is in response to a yaw movement of the head of the user of the electronic device 101.

Additionally, note that the plurality of selectable options 356 include a focus region 358a and non-focus regions 358b. For example, in FIG. 4C, selectable option 356c is in the focus region 358a while the remaining selectable options in the illustration are in the non-focus regions 358b, and in FIG. 4E, selectable option 356e is in the focus region 358a while the remaining selectable options in the illustration are in the non-focus regions 358b. In some examples, when a respective selectable option is in the focus region, it has a first size, and when the respective selectable option is not in the focus region, it has a second size that is less than the first size. For example, a size of the selectable option 356c in FIG. 4C is a first size, and the size of the selectable option 356b in FIG. 4C is a second size that is less than the first size. As such, the electronic device 101 may change a size of a respective user interface element as the user interface element enters and/or exits the focus region 358a. In some examples, when a respective selectable option is in the focus region, it is closer to the user than when it is out of the focus region. In some examples, in the non-focus regions 358b, the closer the selectable option is to the focus region 358a the larger and/or closer in distance the selectable option is to the user. For example, in FIG. 4E, the smallest selectable options in the viewpoint of the user 304 may be the selectable option 356c and the selectable option 356g. Continuing with this example, in FIG. 4E, the selectable option 356d and the selectable option 356f may have a size that is greater than the smallest size and less than a size of selectable option 356e in FIG. 4E.

Note that in the illustrated examples of FIGS. 4A-4C, the electronic device 101 displays a selectable option that corresponds to the user interface 350c of FIG. 4A (e.g., the selectable option 356c). However, such examples are nonlimiting, as the present disclosure contemplates that the electronic device 101 may display a plurality of selectable options that do not include a selectable option that corresponds to the user interface 350c in response to detecting the head movement of FIG. 4B.

Note that the plurality of selectable options 356 behaves as head-locked content. For example, from FIG. 4D to 4E, the electronic device 101 moves the location of the plurality of selectable options 356 in the environment 306 in accordance with the movement of the head of the user. Note that in some examples, the plurality of selectable options 356 does not behave as head-locked content, but has another content locking behavior, such as world-locked.

In some examples, the electronic device 101 returns to displaying a user interface after displaying the plurality of selectable options 356 in response to certain head movement. For example, while displaying the plurality of selectable options 356 as in FIG. 4F, the electronic device 101 detects a head movement of the user 304. In FIG. 4F, the head movement is a downward pitch movement, as shown with arrow 317b being a clockwise rotation of the head of the user 304 (e.g., rotating about the pitch axis of the head of the user) from the head orientation indicated by the arrow 315b to the head orientation indication by the arrow 315a. In some examples, the electronic device 101 in FIG. 4F interprets downward pitch movements as requests to display a user interface that corresponds to a selectable option that is in the focus region 358a of the plurality of selectable options when the downward pitch movement is detected. For example, were the head movement of FIG. 4F not a downward pitch movement, the electronic device 101 of FIG. 4F may not interpret such movement as a request to display the user interface that corresponds to the selectable option that is in the focus region 358a of the plurality of selectable options 356. In response to detecting the downward pitch movement in FIG. 4F, the electronic device 101 may display a user interface 350e, as shown from FIG. 4F to 4G.

From FIG. 4F to 4G, the electronic device 101 ceases display (e.g., fades out) of the plurality of selectable options 356 and displays (e.g., fades in) a user interface 350e. In some examples, the user interface 350e is associated with the selectable option 356e, and the electronic device 101 displays the user interface 350e because the selectable option 356e was in the focus region 358a of the plurality of selectable options 356 when the downward pitch movement of FIG. 4F was detected. In some examples, the electronic device 101 animates display of the user interface 350e by increasing a size of the selectable option 356e and then displaying the user interface 350e, such as the selectable option 356e transforming into the user interface 350e while the other selectable options of the plurality of options 356 are ceasing to be displayed. Note also that the user interface 350e of FIG. 4G has a greater size than the selectable option 356e in FIG. 4F. In some examples, the size of the user interface 350e of FIG. 4G is not greater than the size of the selectable option 356e in FIG. 4F.

Further, note that although the vertical and horizontal direction that the head of the user 304 in FIGS. 4D and 4E is as indicated by the arrow 315b, it is understood that the head direction in those two figures could likewise be as indicated by the arrow 315a of FIG. 4B. For example, after detecting the movement indicated by the arrow 317a in FIG. 4B, the electronic device 101 may permit the user 304 to orient their head back in the direction indicated by the arrow 315a of FIG. 4B without changing display of the plurality of selectable options 356. For example, the electronic device 101 may return to displaying a user interface in response to detecting a downward pitch movement that start from the orientation of the head indicated by the arrow 315a in FIG. 4B rather than from the orientation f the head indicated by the arrow 315b in FIG. 4F.

As described above with reference to FIGS. 4A-4C, in some examples, the electronic device 101 displays a plurality of selectable options in response to detecting an upward pitch movement of the head of the user 304. In some examples, the electronic device 101 displays a plurality of selectable options in response to detecting a downward pitch movement of the head of the user 304, such as shown from FIG. 4H to FIG. 4J.

For example, while displaying the user interface 351j (e.g., a user interface that may include one or more characteristics of the user interface 330, or 350e) as in FIG. 4H, the electronic device 101 detects a downward pitch movement of the head of the user 304, as shown with arrow 317c in FIG. 4H from the head orientation indicated by the arrow 315a to the head orientation indication by the arrow 315c. In some examples, the electronic device 101 interprets downward pitch movements as requests to display a plurality of selectable options. For example, were the head movement of FIG. 4H not a downward pitch movement, the electronic device 101 of FIG. 4H may not interpret such movement as a request to display a plurality of selectable options. In response to detecting the downward pitch movement of the head of the user in FIG. 4H, the electronic device 101 displays a plurality of selectable options 360, as shown in FIG. 4I.

In FIG. 4I, the electronic device 101 concurrently displays the user interface 351j and a plurality of selectable options 360. In FIG. 4I, the plurality of selectable options 360 (e.g., selectable options 360i through 360k) are displayed as icons (e.g., affordances). In some examples, the icons are representations of applications. For example, the selectable option 360i may be a representation of a first application (e.g., an email application), the selectable option 360j may be a representation of a second application (e.g., a weather application), and the selectable option 360k may be a representation of a third application (e.g., a music application). In FIG. 4I, the icon that is in the focus region is the icon that is below the user interface 351j (e.g., the selectable option 360j). Further, the plurality of selectable options 360 may include one or more characteristics of the plurality of selectable options 356 and/or of the selectable options 310a-310e. For example, the plurality of selectable options 360 are horizontally scrollable, as are the illustrated plurality of selectable options 356. As such, FIGS. 4I and 4J illustrate examples of an electronic device 101 displaying content that is scrollable in a direction that corresponds to a direction that is perpendicular (e.g., opposite) the axis of rotation of the head movement that resulted in the electronic device 101 displaying the plurality of selectable options. For example, in FIG. 4I, the electronic device 101 detects a head movement that is about the pitch axis of the user, and in response the electronic device 101 displays user interface elements that are horizontally paginated, as described and illustrated with reference to FIGS. 4I-4J.

In particular, in FIG. 4I, while concurrently displaying the user interface 351j and the plurality of selectable options 360, the electronic device 101 detects a yaw movement of the head of the user of the electronic device 101, as shown with arrow 314e in top down view 312t in FIG. 4I being a counterclockwise rotation of the head of the user 304. In response, the electronic device 101 horizontally scrolls the plurality of selectable options 360, as shown from FIG. 4I to FIG. 4J. Note that the scrolling illustrated from FIG. 4I to FIG. 4J is a horizontal scroll that is in response to a yaw movement of the head of the user of the electronic device 101.

In some examples, the electronic device 101 returns to displaying a user interface after displaying the plurality of selectable options 360 in response to certain head movement. For example, while displaying the plurality of selectable options 360 as in FIG. 4J, the electronic device 101 detects a head movement of the user 304, as such in FIG. 4K. In FIG. 4J, the head movement is an upward pitch movement, as shown with arrow 317d being a counterclockwise rotation of the head of the user 304 (e.g., rotating about the pitch axis of the head of the user) from the head orientation indicated by the arrow 315c to the head orientation indication by the arrow 315a. In some examples, the electronic device 101 of FIG. 4K interprets upward pitch movements as requests to display a user interface that corresponds to a selectable option that is in the focus region of the plurality of selectable options when the upward pitch movement is detected because the head movement that initiated display of the plurality of selectable options 360 was downward pitch movement. For example, were the head movement of FIG. 4K not an upward pitch movement, the electronic device 101 of FIG. 4K may not interpret such movement as a request to display the user interface that corresponds to the selectable option that is in the focus region of the plurality of selectable options 360. In response to detecting the upward pitch movement in FIG. 4K, the electronic device 101 displays a user interface 351i, as shown in FIG. 4L.

From FIG. 4K to FIG. 4L, the electronic device 101 ceases display of the plurality of selectable options 360 and displays a user interface 351i. In some examples, the user interface 351i is associated with the selectable option 360i, and the electronic device 101 displays the user interface 351i because the selectable option 360i was in the focus region of the plurality of selectable options when the upward pitch movement of FIG. 4K was detected.

FIGS. 4M-4O illustrate examples of the electronic device 101 displaying a plurality of selectable options in response to detecting a yaw movement of the head of the user of the electronic device 101, where the plurality of selectable options are vertically scrollable. In FIG. 4M, the electronic device 101 displays a user interface 362s (e.g., which may have one or more characteristics of the user interfaces 330, 350e, 352i, and/or 351j). In FIG. 4N, while displaying the user interface 362s as in FIG. 4M, the electronic device 101 detects a yaw movement of head of the user, as shown with the arrow 314f in the top down view 312y in FIG. 4N. In response, the electronic device 101 displays a plurality of selectable options 364 that are vertically scrollable, as shown in FIG. 4O. Further, the electronic device 101 may vertically scroll the plurality of selectable options 364 in response to detection of pitch movements of the user, as shown in FIGS. 4P through 4R.

In particular, in FIG. 4Q, while displaying the plurality of selectable options 364 as in FIG. 4P, the electronic device 101 detects an upward pitch movement of the head of the user, as shown with arrow 317e in FIG. 4Q being a counterclockwise rotation of the head of the user 304 (e.g., rotating about the pitch axis of the head of the user) from the head orientation indicated by the arrow 315a to the head orientation indication by the arrow 315b. In response to detecting the upward pitch movement of the head of the user in FIG. 4Q, the electronic device 101 scrolls the plurality of selectable options 364 downward as shown from FIG. 4Q to FIG. 4R.

FIGS. 4S and 4T illustrate examples of the electronic device 101 displaying a user interface (e.g., selecting a selectable option that is in the focus region of the plurality of selectable options 364 and then displaying the user interface in response to the selection) in response to certain head movement detected while displaying the plurality of selectable options 364 as in FIG. 4R. In the illustrated example of FIG. 4S, since the plurality of selectable options were initially displayed in response to yaw movement of the head of the user (e.g., in a first direction as indicated by the arrow 314f in FIG. 4N), the electronic device 101 may respond to yaw movement of the head of the user (e.g., in a second direction that is different from the first direction, as indicated by the arrow 314g being in the opposite rotation direction as the rotation direction of the arrow 314f in FIG. 4N) to display the user interface (e.g., to select the selectable option of the plurality of selectable options and then display the user interface). For example, in FIG. 4S, while displaying the plurality of selectable options 364 as in FIG. 4R, the electronic device 101 detects the yaw movement of the user, as indicated by the arrow 314g, and in response the electronic device 101 ceases display of the plurality of selectable options 364 and displays the user interface 362s, which corresponds to the selectable option 364s that was in the focus region of the plurality of selectable options 364 when the yaw movement was detected, as shown in FIG. 4T. As another example, if the selectable option 364q is in the focus region of the plurality of selectable options 364 when the yaw movement in FIG. 4S is detected, the electronic device 101 ceases display of the plurality of selectable options 364 and displays a user interface that corresponds to the selectable option 364q, which would optionally be a user interface that is different from the user interface 362s of FIG. 4T. In some examples, a yaw movement of a head of the user is movement of the head of the user in a direction that is approximately perpendicular to a direction of gravity (e.g., movement around a vertical axis), such as the yaw movement indicated by arrow 314d in FIG. 3E. In some examples, if the ears of the head are oriented approximately perpendicular to a direction of gravity (e.g., a line extending through the ears of the head is approximately perpendicular to the direction of gravity), the yaw movement of the head of the user is side-to-side movement of the head (e.g., horizontal rotational movement of the head), such as the yaw movement indicated by arrow 314d in FIG. 3E, which is in a direction that is approximately perpendicular to a direction of gravity. In some examples, if the head of the user is oriented such that one ear faces down vertically and the other ear faces up vertically (e.g., a line extending through each ear is approximately parallel to a direction gravity), the yaw movement of the head of the user is movement of the head in the direction that is approximately perpendicular to the direction of gravity. In some examples, a pitch movement of a head of the user is movement of the head in a direction that corresponds to upward or downward movement of a head that has ears oriented approximately perpendicular to a direction of gravity (e.g., a line extending through the ears of the head is approximately perpendicular to the direction of gravity), such as the upward movement indicated by the arrow 317a in FIG. 4B. In some examples, if the ears of the head are oriented approximately parallel to the direction of gravity (e.g., a line extending through the ears of the head is approximately parallel to the direction of gravity, such as one ear of the head faces down vertically while the other ear faces up vertically), the pitch movement of the head is upward or downward vertical movement (e.g., movement about a horizontal axis), which in this case would involve upward or downward vertical movement of the ears.

Note that, in some examples, scrolling of a user interface is triggered in response to detecting a gaze of the user of the electronic device 101, a mouse click, detection of touch on a touchpad, a voice of the user of the electronic device, etc. For example, the horizontal scrolling of user interfaces described herein (e.g., with reference to FIGS. 4D and 4E) may, additionally or alternatively, be triggered with eye tracking rather than a pitch rotation (e.g., the pitch movement described with reference to FIG. 4B).

FIGS. 4A-4T are further described with reference to a method 460 in FIG. 4U. FIG. 4U generally illustrates the method 460 for displaying a plurality of user interface elements in response to detecting a head rotation of a user of an electronic device according to some examples of the disclosure. FIG. 4U is a flow diagram illustrating the method 460 for displaying a plurality of user interface elements in response to detecting a head rotation of a user of an electronic device according to some examples of the disclosure. It is understood that method 460 is an example and that more, fewer, or different operations can be performed in the same or in a different order. Additionally, the operations in method 460 described below are, optionally, implemented by running one or more functional modules in an information processing apparatus such as general-purpose processors (e.g., as described with respect to FIGS. 2A-2B) or application specific chips, and/or by other components of FIGS. 2A-2B. Further, note that one or more operations or descriptions of method 460 may likewise be applicable in one or more examples of method 340. Similarly, note that one or more operations or descriptions of method 340 may likewise be applicable in one or more examples of method 460.

Therefore, according to the above, some examples of the disclosure are directed to a method (e.g., method 460 of FIG. 4U) performed at an electronic device (e.g., the electronic device 101) in communication with one or more displays and one or more input devices. The method 460 includes displaying (462), via the one or more displays, a user interface of an application. The method 460 includes while displaying the user interface of the application, detecting (464), via the one or more input devices, a first input corresponding to a request to display a plurality of user interface elements, wherein the first input includes a first head rotation of a head of a user of the electronic device about a first axis associated with the head. The method 460 includes in response to detecting the first head rotation of the head of the user of the electronic device about the first axis, displaying (466), via the one or more displays, the plurality of user interface elements, wherein the plurality of user interface elements is scrollable in response to a second head rotation of a second input that is different from the first input.

Additionally or alternatively, in some examples, the plurality of user interface elements corresponds to different user interfaces of different applications.

Additionally or alternatively, in some examples, the plurality of user interface elements corresponds to different user interfaces of the application.

Additionally or alternatively, in some examples, the plurality of user interface elements includes a first user interface element that represents (e.g., corresponds to and/or is selectable to display) the user interface of the application.

Additionally or alternatively, in some examples, the first axis is a pitch axis of the head of the user of the electronic device. Additionally or alternatively, in some examples, the first head rotation is an upward pitch movement. Additionally or alternatively, in some examples, the first head rotation is a downward pitch movement. Additionally or alternatively, in some examples, the plurality of user interface elements is horizontally scrollable.

Additionally or alternatively, in some examples, the first axis is a yaw axis of the head of the user of the electronic device. Additionally or alternatively, in some examples, the plurality of user interface elements is vertically scrollable.

Additionally or alternatively, in some examples, the method 460 includes while displaying the plurality of user interface elements, detecting, via the one or more input devices, the second input, wherein the second head rotation of the second input is about a second axis associated with the head, that is perpendicular to the first axis associated with the head, and in response to detecting the second head rotation, scrolling the plurality of the user interface elements in accordance with the second head rotation.

Additionally or alternatively, in some examples, the user interface of the application is displayed at a first size in the viewpoint of the user when the first input is detected, and the method 460 includes in response to detecting the first head rotation, converting the user interface of the application to a user interface element of the plurality of user interface elements including changing a size of the user interface of the application from the first size to a second size from the viewpoint of the user that is less than the first size from the viewpoint of the user, and displaying, via the one or more displays, a first user interface element of the plurality of user interface elements, wherein the first user interface element represents the user interface of the application and wherein the first user interface element has the second size from the viewpoint of the user.

Additionally or alternatively, in some examples, the first user interface element has the first size from the viewpoint of the user while in a focus region of the plurality of user interface elements, and the method 460 includes detecting, via the one or more input devices, the second input, including the second head rotation, and in response to detecting the second head rotation, scrolling the plurality of the user interface elements, including in accordance with a determination that a respective user interface element is in the focus region of the plurality of user interface elements while scrolling, displaying the respective user interface element at the second size from the viewpoint of the user, and in accordance with a determination that the respective user interface element is not in the focus region of the plurality of user interface elements while scrolling, displaying the respective user interface element at a third size that is less than or equal to the first size from the viewpoint of the user.

Additionally or alternatively, in some examples, the user interface of the application is displayed at a first size from the viewpoint of the user when the first input is detected, and the method 460 includes in response to detecting the first head rotation, changing a size of the user interface of the application from the first size to a second size from the viewpoint of the user that is less than the first size from the viewpoint of the user, and concurrently displaying, via the one or more displays, a first user interface element of the plurality of user interface elements, wherein the first user interface element represents the user interface of the application, and the user interface of the application at the second size from the viewpoint of the user.

Additionally or alternatively, in some examples, the first head rotation about the first axis is in a first rotation direction, and the method 460 includes while displaying a respective user interface element of the plurality of user interface elements, wherein the respective user interface element is selectable to display a respective user interface of a respective application that corresponds to the respective user interface element, detecting, via the one or more input devices, a respective input corresponding to selection of the respective user interface element, wherein the respective input includes a respective head rotation of the head of the user of the electronic device about the first axis in a second rotation direction, different from the first rotation direction, and in response to detecting the respective head rotation of the head of the user of the electronic device, displaying, via the one or more displays, the respective user interface of the respective application, without displaying user interface elements of the plurality of user interface elements.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

Attention is now generally directed towards examples of an electronic device detecting and responding to inputs that corresponds to request to display a user interface, where the inputs include head rotations of a user of the electronic device according to some examples of the disclosure.

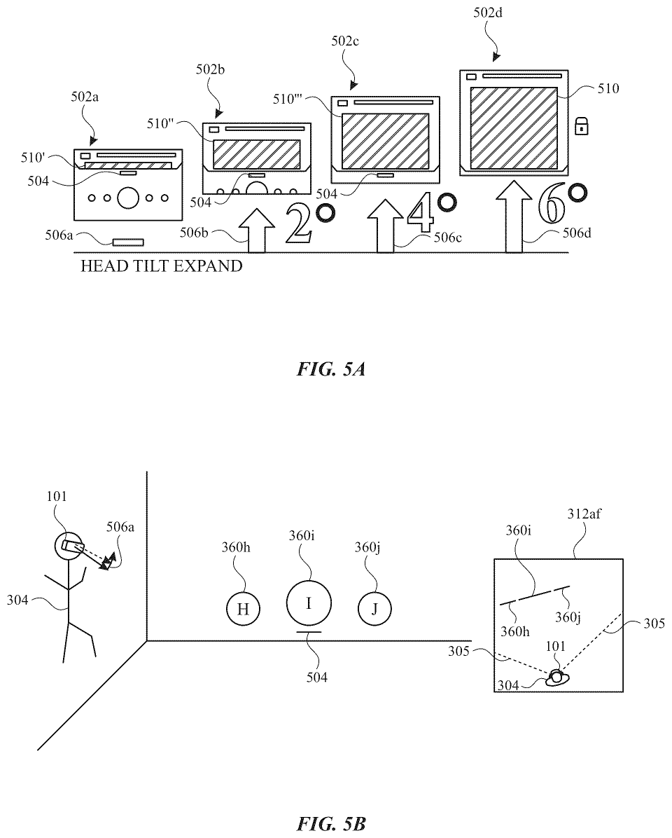

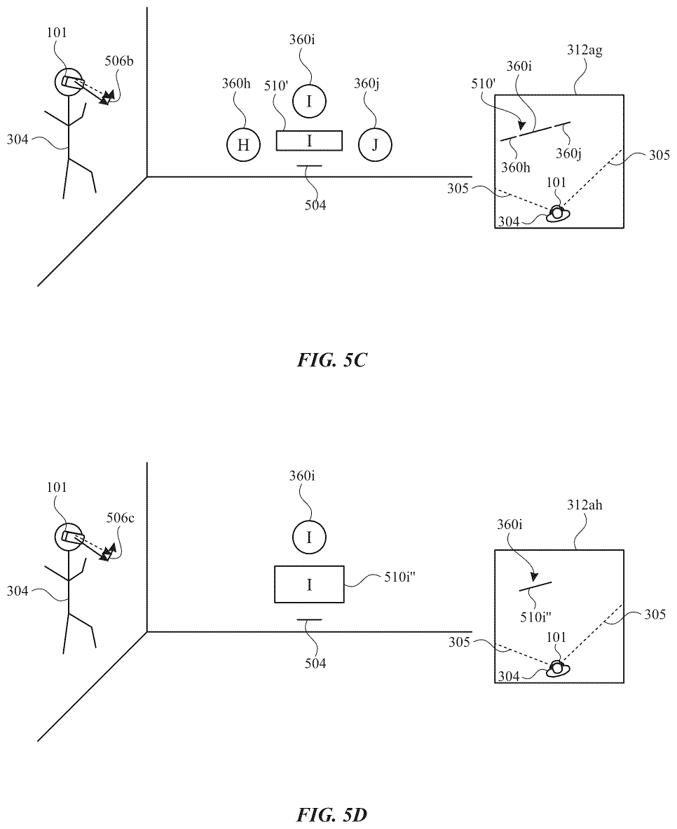

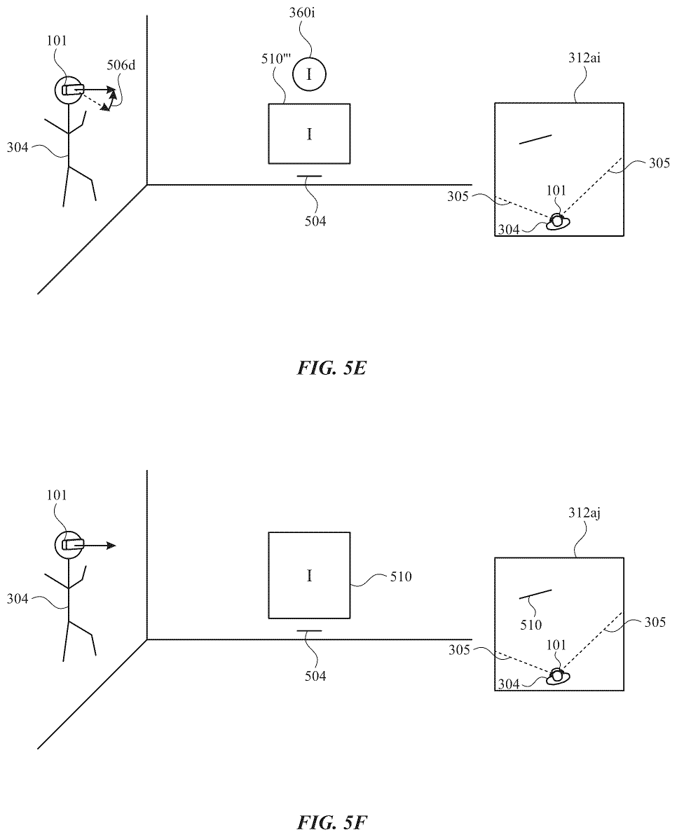

FIGS. 5A-5F generally illustrate examples of an electronic device displaying different amounts of a user interface in accordance with detection of different amounts of head rotations of the user of the electronic device that correspond to requests to display the user interface according to some examples of the disclosure.

FIG. 5A shows schematics 502a-502d that show increasing amounts of a user interface as a function of head movement (e.g., head movement of a user about an axis associated with the head of the user 304, such as the pitch axis of the user). In some examples, the animation of displaying increasing amounts of the user interface mimics a rolling out of a projector screen. For example, the electronic device 101 may display the user interface as if it is rolling out from bottom to top as a function of head movement. For example, in schematic 502a, in response to detecting a first head rotation amount 506a in a first direction (e.g., upward pitch movement of the head of the user), the electronic device 101 displays a first portion 510′ of the user interface 510, and in schematics 502b-502d, the electronic device 101 consecutively increases the amount of the user interface 510 that is displayed (e.g., as shown with the consecutive increases illustrated from the first portion 510′ to the second portion 510″, from the second portion 510″ to the third portion 510′″, and from the third portion 510′″ to the full amount as indication by the user interface 510 in schematic 502d), in accordance with further head movements in the first direction (e.g., consecutive further head movements about the pitch axis of the user as shown with the consecutive increase in head rotation amounts from the first head rotation amount 506a to the second head rotation amount 506b, from the second head rotation amount 506b to the third head rotation amount 506c, and from the third head rotation amount 506c to the fourth head rotation amount 506d) until the full amount of the user interface 510 is displayed as shown by the user interface 510 in schematic 502d. Note also that the reference 504, which is indicative of the bottom of the user interface 510, does not move as the head of the user 304 rotates (e.g., about the pitch axis of the head of the user 304). As such, in FIG. 5A, the bottom of the user interface is tilt-locked while the top of the user interface behaves as head-locked, with the top of the user interface moving (e.g., to display the increasing amounts of the user interface) in response to the upward pitch movements of the user.

FIGS. 5B-5F generally shows the features of the electronic device 101 displaying increasing amounts of a user interface until display of the user interface 510 is reached, as illustrated and described with reference to schematics 502a-502d in FIG. 5A. In particular, FIGS. 5B-5F shows the electronic device 101 displaying more amounts of the user interface 510 consecutively until full display of the user interface 510 is reached, as shown in FIG. 5F.

For the purpose of illustration, FIGS. 5B-5F include respective perspective views and top-down views 312af-312aj. The respective perspective views are generally provided to illustrate certain head movements, and the top-down views 312af-312aj of the respective figures generally illustrate the spatial arrangement between the user 304 and the user interfaces and/or user interface elements displayed in the respective figure. That is, for example, in FIG. 5B, as shown in top-down view 312af, the electronic device 101 is displaying the user interface 350c facing the user 304. Further, FIGS. 5B-5F include viewing boundaries 305 of the user 304 of the electronic device 101 in the respective figure. For example, in FIG. 5A, the electronic device 101 displays a view of (e.g., of a three-dimensional environment) that is bounded by the viewing boundaries 305 in the respective top-down view 312af that is shown in the display of the electronic device 101 from the viewpoint of the user 304 illustrated in the top-down view 312af.

In FIG. 5B, the electronic device 101 is configured to perform the animation described with reference to FIG. 5A. In FIG. 5B, while display the selectable options 360h-360j, the electronic device 101 detects the first head rotation amount 506a (e.g., first amount of upward pitch movement), and in response displays a portion 510′ of the user interface 510, as shown in FIG. 5C. In FIG. 5C, the electronic device 101 detects the second head rotation amount 506b (e.g., second amount of upward pitch movement), and in response displays a portion 510″ of the user interface 510, which is more than the portion 510', as shown in FIG. 5D. In FIG. 5D, the electronic device 101 detects the third head rotation amount 506c (e.g., third amount of upward pitch movement), and in response displays a portion 510′″ of the user interface 510, which is more than the portion 510″, as shown in FIG. 5E. In FIG. 5E, the electronic device 101 detects the fourth head rotation amount 506d (e.g., fourth amount of upward pitch movement), and in response displays (e.g., fully displays) the user interface 510, as shown in FIG. 5F. In some examples, in response to detecting an input corresponding to a request to display a user interface, such as the head movement described with reference to FIG. 4F and/or FIG. 4K, the electronic device 101 animates display of the user interface, as described with reference to FIGS. 5A-5F.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at an electronic device in communication with one or more displays and one or more input devices:
displaying, via the one or more displays, a user interface including content configured to be vertically scrollable in the user interface;
while displaying the user interface including the content, detecting, via the one or more input devices, a first input corresponding to a request to scroll the content, the first input including a yaw movement of a head of a user of the electronic device; and
in response to detecting the yaw movement of the head of the user of the electronic device, vertically scrolling the content in the user interface in accordance with the yaw movement of the head of the user of the electronic device.

2. The method of claim 1, wherein the yaw movement of the head of the user is more than a threshold amount of yaw movement of the head of the user, and wherein the method comprises:
while displaying the user interface including the content and before detecting the first input:
detecting, via the one or more input devices, a first respective amount of yaw movement of the head of the user that is less than the threshold amount of yaw movement of the head of the user; and
in response to detecting the first respective amount of yaw movement, forgoing scrolling the content.

3. The method of claim 2, wherein:
the threshold amount of yaw movement is further associated with an amount of yaw movement of the head of the user over a period of time;
the yaw movement is performed within the period of time; and
the first respective amount of yaw movement is performed over more than the period of time.

4. The method of claim 1, wherein vertically scrolling the content in the user interface in accordance with the yaw movement of the head of the user of the electronic device includes vertically scrolling the content by an amount that is based on an average amount of movement of the head of the user over a period of time.

5. The method of claim 1, comprising in response to detecting the first input, presenting an indication to the user of the electronic device that the content is scrollable in response to a respective yaw movement of the head of the user of the electronic device.

6. The method of claim 1, comprising:
in accordance with a determination that the yaw movement of the head of the user of the electronic device is in a first rotation direction, vertically scrolling the content in a first vertical direction of the user interface; and
in accordance with a determination that the yaw movement of the head of the user of the electronic device is in a second rotation direction, different from the first rotation direction, vertically scrolling the content in a second vertical direction of the user interface that is different from the first vertical direction of the user interface.

7. The method of claim 6, comprising:
in accordance with a determination that the yaw movement of the head of the user of the electronic device is a first amount of rotation in the first rotation direction, vertically scrolling the content in the first vertical direction by a first scrolling amount; and
in accordance with a determination that the yaw movement of the head of the user of the electronic device is a second amount of rotation in the first rotation direction that is different from the first amount of rotation in the first rotation direction, vertically scrolling the content in the first vertical direction by a second scrolling amount that is different from the first scrolling amount.

8. The method of claim 1, wherein when the first input is detected, the user interface is displayed at a first location in a three-dimensional environment, and wherein the method comprises:
in response to detecting the yaw movement of the head of the user of the electronic device, moving the user interface to a second location in the three-dimensional environment that is different from the first location.

9. An electronic device comprising:
one or more processors;
memory, wherein the electronic device in communication with one or more displays and one or more input devices, and wherein the one or more processors are configured to execute one or more programs stored in the memory, the one or more programs including instructions for performing a method comprising:
displaying, via the one or more displays, a user interface including content configured to be vertically scrollable in the user interface;
while displaying the user interface including the content, detecting, via the one or more input devices, a first input corresponding to a request to scroll the content, the first input including a yaw movement of a head of a user of the electronic device; and
in response to detecting the yaw movement of the head of the user of the electronic device, vertically scrolling the content in the user interface in accordance with the yaw movement of the head of the user of the electronic device.

10. The electronic device of claim 9, wherein the yaw movement of the head of the user is more than a threshold amount of yaw movement of the head of the user, and wherein the method comprises:
while displaying the user interface including the content and before detecting the first input:
detecting, via the one or more input devices, a first respective amount of yaw movement of the head of the user that is less than the threshold amount of yaw movement of the head of the user; and
in response to detecting the first respective amount of yaw movement, forgoing scrolling the content.

11. The electronic device of claim 10, wherein:
the threshold amount of yaw movement is further associated with an amount of yaw movement of the head of the user over a period of time;
the yaw movement is performed within the period of time; and
the first respective amount of yaw movement is performed over more than the period of time.

12. The electronic device of claim 9, wherein vertically scrolling the content in the user interface in accordance with the yaw movement of the head of the user of the electronic device includes vertically scrolling the content by an amount that is based on an average amount of movement of the head of the user over a period of time.

13. The electronic device of claim 9, wherein the method comprises in response to detecting the first input, presenting an indication to the user of the electronic device that the content is scrollable in response to a respective yaw movement of the head of the user of the electronic device.

14. The electronic device of claim 9, wherein the method comprises:
in accordance with a determination that the yaw movement of the head of the user of the electronic device is in a first rotation direction, vertically scrolling the content in a first vertical direction of the user interface; and
in accordance with a determination that the yaw movement of the head of the user of the electronic device is in a second rotation direction, different from the first rotation direction, vertically scrolling the content in a second vertical direction of the user interface that is different from the first vertical direction of the user interface.

15. The electronic device of claim 14, wherein the method comprises:
in accordance with a determination that the yaw movement of the head of the user of the electronic device is a first amount of rotation in the first rotation direction, vertically scrolling the content in the first vertical direction by a first scrolling amount; and
in accordance with a determination that the yaw movement of the head of the user of the electronic device is a second amount of rotation in the first rotation direction that is different from the first amount of rotation in the first rotation direction, vertically scrolling the content in the first vertical direction by a second scrolling amount that is different from the first scrolling amount.

16. The electronic device of claim 9, wherein when the first input is detected, the user interface is displayed at a first location in a three-dimensional environment, and wherein the method comprises:
in response to detecting the yaw movement of the head of the user of the electronic device, moving the user interface to a second location in the three-dimensional environment that is different from the first location.

17. A non-transitory computer readable storage medium storing one or more programs, the one or more programs comprising instructions, which when executed by one or more processors of an electronic device that is in communication with one or more displays and one or more input devices, cause the electronic device to perform a method comprising:
displaying, via the one or more displays, a user interface including content configured to be vertically scrollable in the user interface;
while displaying the user interface including the content, detecting, via the one or more input devices, a first input corresponding to a request to scroll the content, the first input including a yaw movement of a head of a user of the electronic device; and
in response to detecting the yaw movement of the head of the user of the electronic device, vertically scrolling the content in the user interface in accordance with the yaw movement of the head of the user of the electronic device.

18. The non-transitory computer readable storage medium of claim 17, wherein the yaw movement of the head of the user is more than a threshold amount of yaw movement of the head of the user, and wherein the method comprises:
while displaying the user interface including the content and before detecting the first input:
detecting, via the one or more input devices, a first respective amount of yaw movement of the head of the user that is less than the threshold amount of yaw movement of the head of the user; and
in response to detecting the first respective amount of yaw movement, forgoing scrolling the content.

19. The non-transitory computer readable storage medium of claim 18, wherein:
the threshold amount of yaw movement is further associated with an amount of yaw movement of the head of the user over a period of time;
the yaw movement is performed within the period of time; and
the first respective amount of yaw movement is performed over more than the period of time.

20. The non-transitory computer readable storage medium of claim 17, wherein vertically scrolling the content in the user interface in accordance with the yaw movement of the head of the user of the electronic device includes vertically scrolling the content by an amount that is based on an average amount of movement of the head of the user over a period of time.

21. The non-transitory computer readable storage medium of claim 17, wherein the method comprises in response to detecting the first input, presenting an indication to the user of the electronic device that the content is scrollable in response to a respective yaw movement of the head of the user of the electronic device.

22. The non-transitory computer readable storage medium of claim 17, wherein the method comprises:
in accordance with a determination that the yaw movement of the head of the user of the electronic device is in a first rotation direction, vertically scrolling the content in a first vertical direction of the user interface; and
in accordance with a determination that the yaw movement of the head of the user of the electronic device is in a second rotation direction, different from the first rotation direction, vertically scrolling the content in a second vertical direction of the user interface that is different from the first vertical direction of the user interface.

23. The non-transitory computer readable storage medium of claim 17, wherein when the first input is detected, the user interface is displayed at a first location in a three-dimensional environment, and wherein the method comprises:
in response to detecting the yaw movement of the head of the user of the electronic device, moving the user interface to a second location in the three-dimensional environment that is different from the first location.

24. The non-transitory computer readable storage medium of claim 17, wherein when the first input is detected, the user interface is displayed at a first location in a three-dimensional environment, and wherein the method comprises:
in response to detecting the yaw movement of the head of the user of the electronic device, maintaining display of the user interface at the first location in three-dimensional environment.
